(19) United States
(12) Patent Application Publication
(10) Pub. No.: US 2009/0137667 A1
(43) Pub. Date: May 28, 2009

(54) Pesticide Delivery System

(75) Inventors: Alexander V. Kabanov, Omaha, NE (US); Tatiana K. Bronitch, Omaha, NE (US); Michael Karas, Marlton, NJ (US)

Correspondence Address: PATENT ADMINISTRATOR;FMC CORPORATION, 1735 MARKET STREET, PHILADELPHIA, PA, 19103, US

(73) Assignee: Innovaform Technologies, LLC, Philadelphia, PA (US)

(21) Appl. No.: 12/160,385

(22) PCT Filed: Jan. 10, 2007
(86) PCT No.: PCT/US07/00559

§ 371 Date: Sep. 25, 2008

Related U.S. Application Data
(60) Provisional application No. 60/757,641, filed on Jan. 10, 2006.
(60) Provisional application No. 60/790,381, filed on Apr. 7, 2006.

(51) Int. Cl. A01N 53/06

(52) U.S. Cl. 514/531

(57) ABSTRACT

An improved pesticide delivery system is disclosed. The system is based on a microblend comprising (a) an amphiphilic compound containing at least one hydrophilic group and at least one hydrophobic group and (b) a pesticide. Compositions based on the microblend and methods of using the compositions to control pests are also disclosed.

### CROSS REFERENCE RELATED APPLICATIONS

This application claims benefit under 35 U.S.C. 119(e) to U.S. Provisional application No. 60/757,641 filed Jan. 10, 2006 and U.S. Provisional application No. 60/790,381 filed Apr. 7, 2006, both of which are hereby incorporated by reference in their entirety.

### FIELD OF THE INVENTION

The present invention relates to pesticidal compositions containing microblends, said blends comprising (a) an amphiphilic compound and (b) a second compound and to uses of the compositions to control pests.

### BACKGROUND OF THE INVENTION

Suspension concentrates, soluble liquids, emulsions, microemulsions, multiple emulsions and other systems are commonly used in pesticidal delivery. These systems generally comprise a pesticide plus a carrier (usually water) and a variety of additives and excipients. Commonly pesticidal formulations are concentrates that are diluted by a considerable amount of liquid before application and then the resulting dispersion is applied.

For example, water-dispersible powders (WP) are finely-divided solid pesticide formulations, which are applied after dilution and suspension in water. They are low cost to produce and pack, easy to handle and versatile, but they are difficult to mix in spray tanks, may be a dust-hazard and may be poorly compatible with other formulations. In some cases they are used with water-soluble sachets to overcome dust-handling hazard problems.

Water-dispersible granules (WG) are another type of solid formulation that are dispersed or dissolved in water in the spray tank. These formulations have important advantages compared to other solid formulations such as the uniform-size free-flowing granules, easiness to pour and measure, good dispersion/solution in water, long term stability at high and low temperatures. Water dispersible or soluble granules can be formulated using various processing techniques. However, the success of the formulation processes depends on the physicochemical properties of the active ingredients, and it can be rather difficult to formulate the lipophilic active ingredients.

Suspension concentrates (SC) are stable suspensions of very small pesticide particles in a fluid. Suspension concentrates may be diluted in water or oil, but presently nearly all suspension concentrate formulations are dispersions in water. Suspension concentrates can be used to formulate very lipophilic active ingredients. These formulations are easy to pour and measure, the water based liquid is non-flammable, but the formulation stability may be sensitive to minor changes in raw material quality, and these formulations need to be protected from freezing. The particle size in the suspension concentrates is in the micron range and consequently, the particles have large surface area. This results in low mobility of the particles, due to their hydrophobic interactions with the environmental surfaces and severely limits the systemicity and bioavailability of the active ingredients delivered using these formulations.

Soluble liquid concentrates (SL) are clear solutions to be applied as a solution after dilution in water. Soluble liquids are based on either water or a solvent mixture which is completely miscible in water. Solution concentrates are easy to handle and prepare, and they merely require dilution into water in the spray tank. However, the number of pesticides which can be formulated in soluble liquid concentrates are limited by the solubility and stability of the active ingredient in water.

Specialized formulations, such as microemulsions, are water-based formulations that are thermodynamically stable over wide temperature ranges due to their very fine droplet size (usually between 50-100 nm) and are sometimes regarded as solubilized micellar solutions. They usually contain active ingredient, solvent, surfactant solubilizers, co-surfactant and water. The surfactant solubilizers often represent a blend of surfactants with different hydrophilic-lipophilic balance (HLB). Such formulations are non-flammable, have long shelf life and have low flammability, but they have also limited number of suitable surfactant systems for active ingredients and may have limited use for niche of markets.

In pharmaceutical preparations, the formulation is typically administered by application to skin, by mouth or by injection. These environments are very specific and are closely controlled by the body. Permeation of the active ingredient through skin depends on the permeability of the skin, which is similar in most patients. Formulations taken by mouth are subject to different environments in sequence, e.g., saliva, stomach acid and basic conditions in the gut, before absorption into the bloodstream, yet these conditions are similar in each patient. Injected formulations are exposed to a different set of specific environmental conditions; still, these environments are similar in each patient. In formulations for all these environments, excipients are important to the performance of the active ingredient. Absorption, solubility, transfer across cell membranes are all dependent on the mediating properties of excipients. Therefore, formulations are designed for specific conditions and specific application methods, which are predictably present in all patients.

By contrast, in agricultural and/or pesticidal applications, an active ingredient may be used in similar formulations and similar application methods to treat many types of crops or pests. Environmental conditions vary greatly from one geographical area to another and from season to season. Agricultural formulations must be effective in a broad range of conditions, and this robustness must be built into a good agricultural formulation.

For agricultural compositions, the surface/air interface is much more important than for pharmaceutical compositions, which operate within the closed system of the body. In addition, agricultural environments contain different components such as clay, heavy metals, and different surfaces such as leaves (waxy hydrophobic structures). The temperature range of soil also varies more widely than the body, and may typically range between 0 and 54 degrees Celsius. The pH of soil ranges from about 4.5 to 10, while pharmaceutical compositions are not typically formulated to release even throughout the broad pH range of between 5-9.

Application of agricultural formulations is generally by spraying a water-diluted formulation directly onto the field either before or after emergence of the crop/weeds. Spraying has utility when the formulation must contact the leafy growing parts of a plant target. Frequently, dry granular formulations are used and are applied by broadcast spreading. These formulations are useful when applied before emergence of the crop and weeds. In such cases the active ingredient must remain in the soil, preferably localized in the region of the growing roots of the target plant or in the active region for the target insects.

### SUMMARY OF THE INVENTION

The present invention relates to pesticidal compositions containing microblends comprising (a) an amphiphilic compound and (b) a pesticide. The present invention also relates to uses of the compositions to control pests. The compositions of the present invention initially are in the form of solvent-free concentrates, that upon dilution with water, form small particles (micelles). As compared to previously available compositions, the pesticidal compositions of the present invention have improved properties such as bioavailability, systemicity, soil mobility, etc.

### BRIEF DESCRIPTION OF THE DRAWINGS

FIG. 1 depicts a graph of the amount of LD₅₀ in parts per million (ppm) of Bifenthrin, a commercial pesticide formulation, and Example A3 as obtained through a Diet Disk Assay.

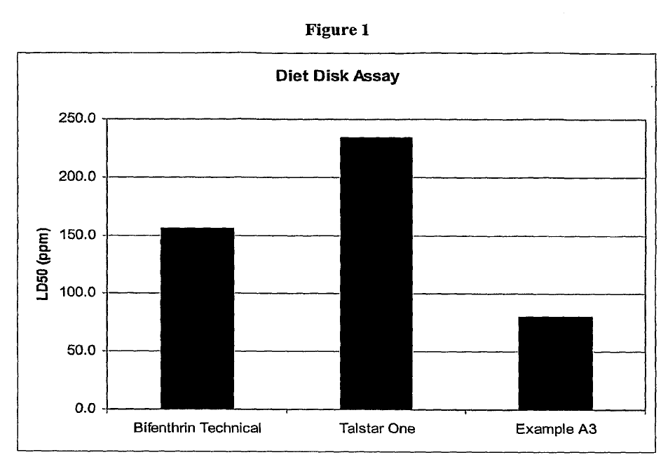

FIG. 2 depicts a graph of the amount of LD₅₀ in parts per million (ppm) of a commercial pesticide formulation and Example A9 as obtained through a Leaf Disk Assay.

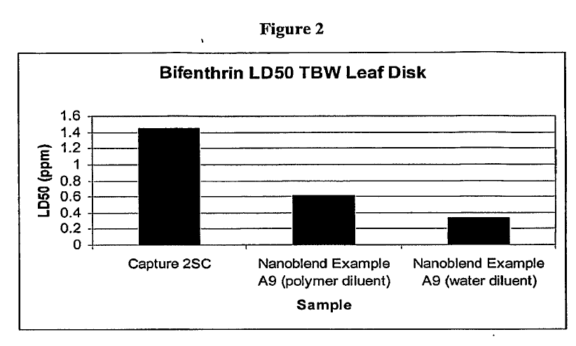

FIG. 3 depicts a plot of the % control versus time of a commercial pesticide formulation, and Example A9 as obtained through a Leaf Disk Assay.

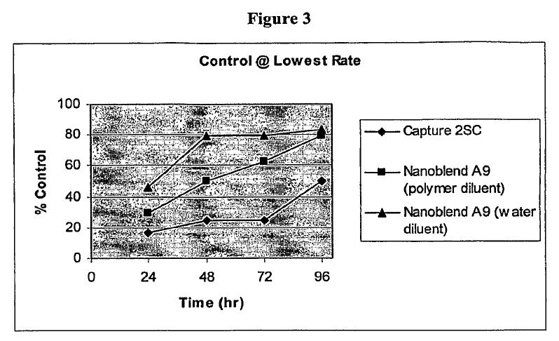

FIG. 4 depicts a graph of the % leaf consumption of untreated leaves, a polymer blank, a commercial pesticide formulation, and Example A9.

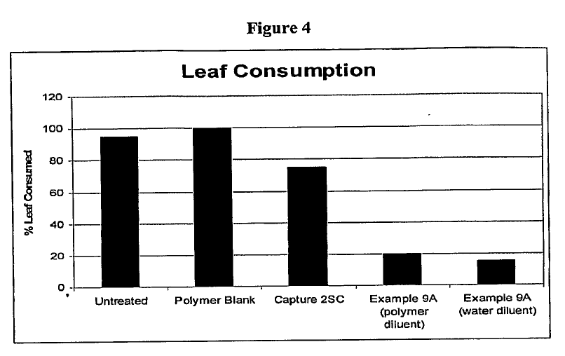

FIG. 5 depicts the images of soil TLC plate after development for microblends containing various Pluronic, Tetronic and Soprophor components. The concentration of bifenthrin in the microblends was 1% (w/w). 50 uL of 10% aqueous dispersions of microblends were applied on the plate.

FIG. 6 depicts the images of soil TLC plate after (A) first development and (B) second development for microblends containing various ratios of Pluronic P123 and Soprophor 4D 384 components. The content of bifenthrin in microblends was 1% (w/w). 50 uL of 10% aqueous dispersions of microblends were applied on the plate.

### DETAILED DESCRIPTION OF THE INVENTION

To the extent used herein the following terms have the indicated meanings, explanations:
Ampholyte: A substance that may act as either an acid or a base.
Amphiphilic surfactant: A surfactant containing ionic or ionizable polar head group(s) and one or more hydrophobic tail groups.
Backbone: Used in graft copolymer nomenclature to describe the chain onto which the graft is formed.
Block copolymer: A combination of two or more chains of constitutionally or configurationally different features covalently linked in a linear fashion to each other.
Branched polymer: A combination of two or more chains linked to each other, in which at least one chain is bonded at some point along the other chain.
Chain: A polymer molecule formed by covalent linking of monomeric units.
Configuration: Organization of atoms along the polymer chain, which can be interconverted only by the breakage and reformation of primary chemical bonds.
Conformation: Arrangements of atoms and substituents of the polymer chain brought about by rotations about single bonds.
Copolymer: A polymer that is derived from more than one species of monomer.
Cross-link: A structure bonding two or more polymer chains together.
Dendrimer: A branched polymer in which branches start from one or more centers.
Dilution An amount of water added to the composition of the invention to form a dispersion where the amount of the dispersion exceeds the mass of the composition by at least one order of magnitude, preferably the water:composition is 10:1 to 10,000:1, more preferably 100:1 to 1000:1, even more preferably from 25:1 to 200:1.
Dispersion: Particulate matter distributed throughout a continuous medium.
Graft copolymer: A block copolymer representing a combination of two or more chains of constitutionally or configurationally different features, one of which serves as a backbone main chain, and at least one of which is bonded at some points along the backbone and constitutes a side chain.
Homopolymer: Polymer that is derived from one species of monomer.
Link: A covalent chemical bond between two atoms, including bond between two monomeric units, or between two polymer chains.
LogP: The octanol/water partition coefficient (P) is a measure of differential solubility of a compound in two solvents, octanol and water. LogP is the logarithmic ratio of the concentrations of the solute in the two solvents.
Microblend: A composition (a) resulting from the intimate mixture of the first amphiphilic compound and the second compound and/or pesticide which (b) after dilution in water results in a dispersion having particle size in the nanoscale range—i.e. less than about 500 nanometers, preferably less than about 300 nanometers, more preferably less than about 100 nanometers and even more preferably less than about 50 nanometers. Typical dilution rates of water:composition are 100:1 and 1,000:1.
Polymer network: A three-dimensional polymer structure, where all the chains are connected through cross-links.
Pesticide: A substance or mixture of substances used to prevent, destroy, repel, mitigate, or control pests such as insects, weeds, mites, fungi, nematodes and the like which are harmful to growing crops, livestock, pets, humans, and structures. Examples of pesticides include bactericides, herbicides, fungicides, insecticides (e.g., ovicides, larvicides, or adulticides), miticides, nematicides, rodenticides, virucides, plant growth regulators, and the like. A pesticide is also any substance or mixture of substances intended for use as a plant regulator, defoliant, or desiccant.
Polyampholyte: A polymer chain having mixed anion and cation character.
Polyanion: A polymer chain containing repeating units containing groups capable of ionization resulting in formation of negative charges on the polymer chain.
Polycation: A polymer chain containing repeating units containing groups capable of ionization resulting in formation of positive charges on the polymer chain.
Polyion: A polymer chain containing repeating units containing groups capable of ionization in aqueous solution resulting in formation of positive charges and/or negative charges on the polymer chain.
Blend: An intimate combination of two or more polymers chains or other chemical compounds of constitutionally or configurationally different features, which are not chemically bonded to each other.
Polymer block: A portion of polymer molecule in which the monomeric units have at least one constitutional or configurational feature absent from adjacent portions. The term polymer block is used interchangeably with polymer segment or polymer fragment.
Poorly Soluble Solubility in Water of about 500 ppm to about 1000 ppm in Deionized Water at 25° C. and at atmospheric pressure.
Repeating unit: Monomeric unit linked into a polymer chain.
Side chain: The grafted chain in a graft copolymer.
Stable: Stability in aqueous dispersion with no precipitation and no chemical decomposition of the active ingredient for the durations necessary for the application of the microblend composition.
Starblock copolymer: Three or more chains of different constitutional or configurational features linked together at one end through a central moiety.
Star polymer: Three or more chains linked together at one end through a central moiety.
Surfactant: Surface active agent.
Water Insoluble: Solubility of less than 500 ppm, preferably less than 100 ppm, in Deionized water at 25° C. and at atmospheric pressure.
Zwitterion: A dipolar ion that contains ionic groups of opposite charge, and has a net charge of zero.

### PREFERRED EMBODIMENTS

The present invention relates to pesticidal compositions containing microblends of (a) an amphiphilic compound and (b) a pesticide that is poorly soluble in water. Each of these is discussed separately below.

### (a) The Amphiphilic Compound

The amphiphilic compound useful in the present invention is generally a polymer comprising at least one hydrophilic moiety and at least one hydrophobic moiety and will typically be polymeric. Representative amphiphilic compounds include hydrophilic-hydrophobic block copolymers, such as those described below. Block copolymers of polyethylene oxide and another polyalkylene oxide are preferred, especially polyethylene oxide/polypropylene oxide block copolymers as described below.

A second compound may be combined with the amphiphilic compound to form the microblend and suitable compounds may be selected from:
a hydrophobic homopolymer or random copolymer
an amphiphilic polymer with the same moieties as the first amphiphilic compound but with different lengths of at least one of the hydrophilic or hydrophobic moieties or different configuration of the polymer chain
an amphiphilic polymer with at least one of the moieties chemically different from the hydrophilic or hydrophobic moieties in the first amphiphilic compound
a hydrophobic block copolymer comprising at least two different hydrophobic blocks,
a hydrophobic molecule, and
a hydrophobic molecule linked to a hydrophilic polymer.

If the second compound in this invention is a hydrophobic homopolymer or random copolymer, it is preferably selected from the list of hydrophobic polymers described below.

If the second compound is an amphiphilic compound with the same moieties as the first amphiphilic compound but with different lengths of at least one of the hydrophilic or hydrophobic moieties or different configuration of the polymer chain it is preferred that such compound is more hydrophobic than the first amphiphilic compound. A second compound is more hydrophobic than a first compound If the HLB of the second compound is less than the HLB of the first compound.

If the second compound is an amphiphilic polymer with at least one of the moieties chemically different from the hydrophilic or hydrophobic moieties in the first amphiphilic compound it is also preferred that it is more hydrophobic than the first compound. Examples of such second more hydrophobic compounds include but are not limited to block copolymers with a hydrophobic block which is more hydrophobic than the hydrophobic block of the first compound or a block copolymer with a hydrophilic block which is less hydrophilic than the hydrophilic block of the first compound. If the second compound is a block copolymer comprising at least two different hydrophobic blocks, such copolymer may have no hydrophilic blocks. Examples of such hydrophobic block copolymers include elastomers such as KRATON® polymers. KRATON D polymers and compounds have an unsaturated rubber mid-block (styrene-butadiene-styrene, and styrene-isoprene-styrene). KRATON G polymers and compounds have a saturated mid-block (styrene-ethylene/butylene-styrene, and styrene-ethylene/propylene-styrene). KRATON FG polymers are G polymers grafted with functional groups such as maleic anhydride. KRATON isoprene rubbers are high molecular weight polyisoprenes. Particularly preferred copolymers are polystyrene-polyisoprene copolymers: Vector 4411A (44% of styrene content, MW 75,000) from Dexco Polymers LP, Kraton D1117P (17% styrene content) from Shell Chemical Co, and polystyrene-polybutadiene-polystyrene copolymer from Dexco Polymers LP, Vector 8505 (29% styrene content).

If the second compound is a hydrophobic molecule, it can essentially be any organic molecule containing aliphatic or aromatic hydrocarbon or fluorocarbon groups or a mixture of hydrocarbon and fluorocarbon moieties. If the hydrophobic molecule is a fluorocarbon, it will contain either a fluoroalkyl or fluoroaryl moiety. The hydrophobic molecule may also be an aromatic multi-ring compound. For aromatic multi-ring second compounds, compounds with less than about 20 rings are preferred. The molecular weight of the hydrophobic molecule is less than about 2500, preferably less than about 1500. The preferred hydrophobe contains polyaryltriphenyl phenol. In one preferred embodiment such second compound is a pesticide.

If the second compound is a hydrophobic molecule linked to a hydrophilic polymer it can be an amphiphilic surfactant. Particularly preferred in this embodiment are the polyoxyethylated surfactants including non-polymeric surfactants as described below. The hydrophobic molecule can essentially be any organic molecule containing aliphatic or aromatic hydrocarbon or fluorocarbon groups or a mixture of hydrocarbon and fluorocarbon moieties. If the hydrophobic molecule is a fluorocarbon, it will contain either a fluoroalkyl or fluoroaryl moiety. The hydrophobic molecule may also be an aromatic multi-ring compound. For aromatic multi-ring second compounds, compounds with less than about 20 rings are preferred. The molecular weight of the hydrophobic molecule is less than about 2500, preferably less than about 1500. The preferred hydrophobe contains polyaryltriphenyl phenol. It is preferred that the hydrophobic molecules are linked to a hydrophilic molecule, preferably poly(ethylene oxide). Preferably, the number of ethylene oxide units in such non-polymeric surfactants ranges from 3 to about 50. The molecular weight of the hydrophilic polymer is less than about 2500, preferably less than about 1500. In a preferred embodiment, these non-polymeric surfactants may contain at least one charged moiety, which can be either cationic or anionic. Preferably, the charged group is an anionic group, more preferably a sulfogroup or a phosphate group.

Without limiting this invention to a specific formulation, this invention provides microblend concentrates which can be formulated as dust formulations, water dispersible granules, tablets, liquids, wettable powders, or similar dry formulations that are diluted in water before application or are applied in a concentrated e.g. solid form or liquid form. It is preferred that such compositions are substantially free of added water or water-miscible organic solvents. Within the context of this invention, substantially free means containing 0.1% or less of added water or water-miscible solvent. In a preferred embodiment, the microblend concentrates produce stable aqueous dispersions with the particle size in the nanoscale range after dilution with water.

In another preferred embodiment of the present invention the microblend composition are formulated to further contain charged molecules such as cationic or anionic amphiphilic compounds that include hydrophilic-hydrophobic block copolymers with respectively charged repeating units. In another aspect of this invention the cationic or anionic amphiphilic surfactants may be added in the pesticidal compositions.

### (b) The Pesticides

The pesticides that can be used in the present invention include, for example, insecticides, herbicides, fungicides, miticides and nematicides. The pesticides are active ingredients in the microblend compositions of this invention. For pesticides the preferred log P is at least 0, preferably at least 1, and more preferably at least 2. The representative pesticides include but are not limited to the active ingredients listed in the following table:

| | |
|---|---|
| pH = 2 | pH = 7 |

| Compound | Average | STD | Average | STD |
|---|---|---|---|---|
| Pyraclostrobin | 4.530 | 0.002 | 4.487 | 0.003 |
| Propiconazole | 3.301 | 0.001 | 3.287 | 0.009 |
| Hexaconazole | 3.353 | 0.000 | 3.309 | 0.001 |
| Chlorthalonil | 4.357 | 0.006 | 4.234 | 0.002 |
| Triflumizole | 2.605 | 0.000 | 3.887 | 0.001 |
| Difenconazole | 4.078 | 0.000 | 4.017 | 0.002 |
| Flutriafol | 2.123 | 0.006 | 2.039 | 0.001 |
| Azoxystrobin | 3.074 | 0.000 | 3.050 | 0.005 |
| Tebuconazole | 3.445 | 0.001 | 3.488 | 0.002 |
| Febenuconazole | 3.716 | 0.006 | 3.730 | 0.005 |
| Tolyfluanid | 3.934 | 0.011 | 3.930 | 0.000 |
| Fluazinam | 5.033 | 0.002 | 4.719 | 0.008 |
| Prowl | 5.108 | 0.004 | 5.101 | 0.006 |
| Tolclofos-methyl | 4.416 | 0.004 | 4.418 | 0.001 |
| Trifluran | 5.108 | 0.000 | 5.084 | 0.003 |
| Ioxynil Octanoate | 5.668 | 0.022 | 5.598 | 0.002 |
| Butachlor | 4.125 | 0.003 | 4.152 | 0.011 |
| Dinocap | 5.457 | 0.003 | 5.428 | 0.007 |
| Clodinofop-Propargyl | 4.519 | 0.001 | 4.522 | 0.002 |
| Diflufenican | 4.807 | 0.008 | 4.760 | 0.014 |
| Pentachloronitrobenzene | 5.387 | 0.001 | 5.339 | 0.006 |
| Carfentrazone-ethyl | 3.989 | 0.002 | 4.018 | 0.012 |
| Dithiopyr | 4.315 | 0.008 | 4.284 | 0.006 |
| Fluazifop-butyl | 4.437 | 0.005 | 4.418 | 0.002 |
| Trisulfuron-methyl | 3.542 | 0.005 | 0.510 | 0.003 |
| Clethodim | 4.245 | 0.019 | 0.813 | 0.025 |
| Myclobutanil | 2.436 | | 2.798 | 0.008 |

*** Based on the logP assigned to toluene of 2.605 and triphenylene of 6.266 ***
Internally standardized with toluene and triphenylene

Insecticides include, for example; Bifenazate, Quinalphos, Tebupirimfos, Pirimiphos-methyl, Azinphos-ethyl, Phenthoate, Endrin, Dieldrin, Endosulfan, Fenthion, Diazinon, Fonofos, Chlorpyrifos methyl, Sulfluramid, Isoxathion, Cadusafos, Milbemectin A4, Milbemectin A3, Bioallethrin, Bioallethrin S-cyclopentenyl isomer, Allethrin, Terbufos, Thiobencarb, Orbencarb, Buprofezin, Coumaphos, Methoxyfenozide, Tetramethrin, Tetramethrin[(1R)-isomers], Phoxim, Phosalone, Tebufenozide, Propargite, Pyridaben, Teflubenzuron, Fenoxycarb, Chlorpyrifos, Profenofos, Pyrethrins, Chromafenozide, Ethion, Heptachlor, Butralin, Bistrifluoron, Cyhexatin, Amitraz, Chlorfenapyr, Pyriproxyfen, Temephos, Prothiofos, Fenpropathrin, Lufenuron, Resmethrin, Bioresmethrin, Novaluron, Tefluthrin, Dicofol, Hexaflumuron, Diafenthiuron, Lambda-cyhalothrin, Dinocap, Cyhalothrin, Dinocap, Fenpyroximate, Flucythrinate, Cypermethrin, Theta-cypermethrin, Zeta-cypermethrin, Alpha-cypermethrin, Beta-cypermethrin, Kinoprene, Cyfluthrin, Beta-cyfluthrin, Deltamethrin, DDT, Esfenvalerate, Fenvalerate, Permethrin, Etofenprox, Bifenthrin, Tralomethrin, Acrinathrin, Tau-fluvalinate, and Acequinocyl.

Herbicides include, for example; Cafenstrole, Flamprop-M-methyl, Mefenacet, Metosulam, Cloransulam-methyl, MCPA-thioethyl, Oxadiargyl, Napropamide, Carfentrazone-ethyl, Pyriminobac-methyl, Dinitramine, Pyrazoxyfen, Clodinafop-propargyl, Disulfoton, Diflubenzuron, Butachlor, Bromofenoxim, Fluacrypyrim, Isoxaben, Triflumuron, Butylate, Bromobutide, Neburon, Triflusulfuron-methyl, Isofenphos, Cycloxydim, Fluoroxypur-meptyl, Daimuron, Fluazifop, Naproanilide, Pirimiphos-ethyl, Pyraflufen-ethyl, Anilofos, Cinmethylin, Bensulide, Fluridone, Sethoxydim, Dithiopyr, Ethalfluralin, Flamprop-M-isopropyl, Pyrazolynate, Triallate, Fluchloralin, Quizalofop-acid, Propaquizafop-acid, Aclonifen, Prosulfocarb, Fenoxaprop-P, Haloxyfop, Pendimethalin, Clethodim, Prodiamine, Oxadiazon, Fluoroglycofen, Clomeprop, Bispyribac, Haloxyfop-methyl, Trifluralin, Benfluralin, Butralin, Cinidon-ethyl, Acifluorfen-sodium, Acifluorfen, Diclofop, Pyributicarb, Diflufenican, Bifenox, Cyhalofopi-butyl, Quizalofop-ethyl, Quizalofop-P-ethyl, Haloxyfop-etotyl, Fenoxaprop-P-ethyl, Sulcofuron, Diclofop-methyl, Butroxydim, Bromoxynil octanoate, Fluoroglycofen-ethyl, Picolinafen, Flumiclorac-pentyl, Clefoxidim or clefoxydim, Lactofen, Fluazifop-butyl, Fluazifop-P-butyl, Oxyfluorfen, Ioxynil octanoate, Flumetralin, Oxaziclomefone, MCPA-2-ethylhexyl, and Propaquizafop.

Fungicides include, for example; Tolylfluanid, Biphenyl, Zoxamide, Fluoroxypur-meptyl, Ethirimol, Tecnazene, Diflumetorim, Penconazole, Ipconazole, Chlozolinate, Pentachlorophenol, Edifenphos, Phthalide, Silthiofam, Tolclofos-methyl, Quintozene, KTU 3616, Flusulfamide, Dimethomorph, Prochloraz, Pencycuron, Oxpoconazole fumarate, Spiroxamine, Difenoconazole, Metominostrobin, Piperalin, Pyributicarb, Azoxystrobin, Fluazinam, Fenpropimorph, Fenpropidin, Dinocap, Dodemorph, Tridemorph, and Oleic acid.

Nematicides include, for example; Isazofos, Ethoprophos, Triazophos, Cadusafos, and Terbufos.

These and other pesticides alone or in combination can be used in the pesticide compositions of this invention. Furthermore, if the log P of the pesticide is high, i.e., on the order of about 2 or above, it is possible for the pesticide to also function as the second hydrophobic compound in the pesticidal compositions, in which case the microblend comprises the amphiphilic compound and the pesticide. Preferably, the pesticides used herein are poorly water soluble. Particularly preferred are pesticides that are water insoluble.

### Hydrophilic-Hydrophobic Block Copolymers

In a preferred embodiment the first compound of the invention is an amphiphilic block copolymer that comprises at least one hydrophilic block and at least one hydrophobic block linked to each other (also termed herein hydrophilic-hydrophobic block copolymers). Without foregoing the generality of this invention, the following describes examples of hydrophilic and hydrophobic polymers and polymer blocks that can be used in different combinations with each other to form hydrophilic-hydrophobic block copolymers. The skilled artisans can synthesize these and other polymers that may be used in the present invention to prepare the pesticidal compositions.

### Hydrophilic Polymers and Polymer Blocks:

Hydrophilic blocks can be nonionic polymers, anionic polymers (polyanions), cationic polymers (polycations), cationic/anionic polymers (polyampholytes), and zwitterionic polymers (polyzwitterions). Each of these polymers or polymer blocks can be either a homopolymer or a copolymer of two or more different monomers.

Examples of nonionic hydrophilic polymers and polymer blocks according to the invention include but are not limited to polymers comprising repeating units derived from one or several different monomers such as: esters of unsaturated ethylenic carboxylic or dicarboxylic acids or N-substituted derivatives of the esters of unsaturated ethylenic carboxylic or dicarboxylic acids, amides of unsaturated carboxylic acids, 2-hydroxyethyl acrylate and methacrylate, 2-hydroxypropyl methacrylate, acrylamide, methacrylamide, ethylene oxide (also called ethylene glycol or oxyethylene), vinyl monomers (such as vinylpyrrolidone). The examples of nonionic hydrophilic polymers and polymer blocks include but are not limited to polyethylene oxide (also called polyethylene glycol or polyoxyethylene), polysaccharide, polyacrylamide, polymethacrylamide, poly(2-hydroxypropyl methacrylate), polyglycerol, polyvinylalcohol, polyvinyl pyrrolidone, polyvinylpyridine N-oxide, copolymer of vinylpyridine N-oxide and vinylpyridine, polyoxazoline, or polyacroylmorpholine or the derivatives thereof. Each of the nonionic hydrophilic polymers and polymer blocks can be a copolymer containing more than one type of monomeric units including a combination of at least one hydrophilic nonionic unit with at least one of charged or hydrophobic units. Without limiting the generality of this invention it is preferred that the portion of charged or hydrophobic units is relatively low so that the polymer or polymer block remains largely nonionic and hydrophilic in nature.

Examples of polyanions and polyanion blocks include, but are not limited to: polymers and their salts comprising units deriving from one or several monomers including: unsaturated ethylenic monocarboxylic acids, unsaturated ethylenic dicarboxylic acids, ethylenic monomers comprising a sulphonic acid group, their alkali metal and ammonium salts. Examples of these monomers include acrylic acid, methacrylic acid, aspartic acid, alpha-acrylamidomethylpropanesulphonic acid, 2-acrylamido-2-methylpropanesulphonic acid, citrazinic acid, citraconic acid, trans-cinnamic acid, 4-hydroxy cinnamic acid, trans-glutaconic acid, glutamic acid, itaconic acid, fumaric acid, linoleic acid, linolenic acid, maleic acid, nucleic acids, trans-beta-hydromuconic acid, trans-trans-muconic acid, oleic acid, 1,4-phenylenediacrylic acid, phosphate 2-propene-1-sulfonic acid, ricinoleic acid, 4-styrene sulfonic acid, styrenesulphonic acid, 2-sulphoethyl methacrylate, trans-traumatic acid, vinylsulfonic acid, vinylbenzenesulphonic acid, vinyl phosphoric acid, vinylbenzoic acid and vinylglycolic acid and the like as well as carboxylated dextran, sulphonated dextran, heparin and the like. The polyanion blocks have several ionizable groups that can form net negative charge. Preferably, the polyanion blocks will have at least about 3 negative charges, more preferably, at least about 6, still more preferably, at least about 12. The examples of polyanions include, but are not limited to: polymaleic acid, polyaspartic acid, polyglutamic acid, polylysine, polyacrylic acid, polymethacrylic acid, polyamino acids and the like. The polyanions and polyanion blocks can be produced by polymerization of monomers that themselves may not be anionic or hydrophilic, such as for example, tert-butyl methacrylate or citraconic anhydride, and then converted into a polyanion form by various chemical reactions of the monomeric units, for example hydrolysis, resulting in appearance of ionizable groups. The conversion of the monomeric units may be incomplete resulting in a copolymer where a portion of the copolymer units do not have ionizable groups, such as for a example, a copolymer of tert-butyl methacrylate and methacrylic acid. Each of the polyanions and polyanion blocks may be a copolymer containing more than one type of monomeric units including a combination of anionic units with at least one other type of units including anionic units, cationic units, zwitterionic units, hydrophilic nonionic units or hydrophobic units. Such polyanions and polyanion blocks can be obtained by copolymerization of more than one type of chemically different monomers. Without limiting the generality of this invention, it is preferred that the portion of the non-anionic units is relatively low so that the polymer or polymer block remains largely anionic and hydrophilic in nature.

Examples of polycations and polycation blocks include, but are not limited to: polymers and their salts comprising units deriving from one or several monomers being: primary, secondary and tertiary amines, each of which can be partially or completely quaternized forming the quaternary ammonium salts. Examples of these monomers include cationic aminoacids (such as lysine, arginine, histidine), alkyleneimines (such as ethyleneimine, propyleneimine, butileneimine, pentyleneimine, hexyleneimine, and the like), spermine, vinyl monomers (such as vinylcaprolactam, vinylpyridine, and the like), acrylates and methacrylates (such as N,N-dimethylaminoethyl acrylate, N,N-dimethylaminoethyl methacrylate, N,N-diethylaminoethyl acrylate, N,N-diethylaminoethyl methacrylate, t-butylaminoethyl methacrylate, acryloxyethyltrimethyl ammonium halide, acryloxyethyldimethylbenzyl ammonium halide, methacrylamidopropyltrimethyl ammonium halide and the like), allyl monomers (such as dimethyl diallyl ammoniam chloride), aliphatic, heterocyclic or aromatic ionenes. The polycation blocks have several ionizable groups that can form net positive charge. Preferably, the polycation blocks will have at least about 3 negative charges, more preferably, at least about 6, still more preferably, at least about 12. The polycations and polycation blocks may be produced by polymerization of monomers that themselves may not be cationic, such as for example, 4-vinylpyridine, and then converted into a polycation form by various chemical reactions of the monomeric units, for example alkylation, resulting in appearance of ionizable groups. The conversion of the monomeric units may be incomplete, resulting in a copolymer having a portion of the units that do not have ionizable groups, such as for example, a copolymer of vinylpyridine and N-alkylvinylpyridinuim halide. Each of the polycations and polycation blocks can be a copolymer containing more than one type of monomeric units including a combination of cationic units with at least one other type of units including cationic units, anionic units, zwitterionic units, hydrophilic nonionic units or hydrophobic units. Such polycations and polycation blocks can be obtained by copolymerization of more than one type of chemically different monomers. Without limiting the generality of this invention it is preferred that the portion of the non-cationic units is relatively low so that the polymer or polymer block remains largely cationic in nature. Examples of commercially available polycations include polyethyleneimine, polylysine, polyarginine, polyhistidine, polyvinyl pyridine and its quaternary ammonium salts, copolymers of vinylpyrrolidone and dimethylaminoethyl methacylate (Agrimer) and copolymers of vinylcaprolactam, vinylpyrrolidone and dimethylaminoethyl methacylate available from ISP, guar hydroxypropyltrimonium chloride and hydroxypropyl guar hydroxypropyltriammonium chloride (Jaguar) available from Rhodia, copolymers of 2-methacryloyl-oxyethyl phosphoryl choline and 2-hydroxy-3-methacryloyloxypropyltrimethylamrnmonium chloride (Polyquatemium-64) available from NOF Corporation (Tokyo, Japan), N,N-dimethyl-N-2-propenyl-chloride or N,N-Dimethyl-N-2-propenyl-2-propen-1-aminium chloride (Polyquaternium-7), quaternized hydroxyethyl cellulose polymers with cationic substitution of trimethyl ammonium and dimethyldodecyl ammonium available from Dow, quaternized copolymer of vinylpyrrolidone and dimethylaminoethyl methacrylate (Polyquaternium-11), copolymers of vinylpyrrolidone and quaternized vinylimidazol (Polyquaternium-16 and Polyquatemium-44), copolymer of vinylcaprolactam, vinylpyrrolidone and quaternized vinylimidazol (Polyquatemium-46) available from BASF, quaternary ammonium salts of hydroxyethylcellulose reacted with trimethyl ammonium substituted epoxide (Polyquatemium-10) available from Dow.

Examples of polyampholytes and polyampholyte blocks include, but are not limited to: polymers comprising at least one type of unit containing anionic ionizable group and at least one type of unit containing cationic ionizable group derived from various combinations of monomers contained in polyanions and polycations as described above. For example, polyampholytes include copolymers of [(methacrylamido)propyl]-trimethylammonium chloride and sodium styrene sulfonate and the like. Each of the polyampholytes and polyampholyte blocks can be a copolymer containing combinations of anionic and cationic units with at least one other type of units including zwitterionic units, hydrophilic nonionic units or hydrophobic units.

Zwitterionic polymers and polymer blocks include but are not limited to polymers comprising units deriving from one or several zwitterionic monomers, including: betaine-type monomers, such as N-(3-sulfopropyl)-N-methacryloylethoxyethyl-N,N-dimethyl-ammonium betaine, N-(3-sulfopropyl)-N-methacrylamidopropyl-N,N-dimethyl-ammonium betaine, phosphorylcholine-type monomers such as 2-methacryloyloxyethyl phosphorylcholine; 2-methacryloyloxy-2′-trimethylammoniumethyl phosphate inner salt, 3-dimethyl(methacryloyloxyethyl)ammoniumpropanesulfonate, 1,1′-binaphhthyl-2,2′-dihydrogen phosphate, and other monomers containing zwitterionic groups. Each of the zwitterionic polymers and polymer blocks may be a copolymer containing combinations of zwitterionic units with at least one other type of units including anionic units, cationic units, hydrophilic nonionic units or hydrophobic units. Without limiting the generality of this invention it is preferred that the portion of non-zwitterionic units is relatively low so that the polymer or polymer block remains largely zwitterionic in nature.

It is generally believed that the functional groups of polyanions, polycations, polyampholytes and some polyzwitterions can ionize or dissociate in an aqueous environment resulting in formation of charges in a polymer chain. The degree of ionization depends on the chemical nature of the ionizable monomeric units, the neighboring monomeric units present in these polymers, the distribution of these units within the polymer chain, and the parameters of the environment, including pH, chemical composition and concentration of solutes (such as nature and concentration of other electrolytes present in the solution), temperature, and other parameters. For example, polyacids, such as polyacrylic acid are more negatively charged at higher pH and less negatively charged or uncharged at lower pH. The polybases, such as polyethyleneimine are more positively charged at lower pH and less positively charged or uncharged at higher pH. The polyampholytes, such as copolymers of methacrylic acid and poly((dimethylamino)-ethyl methylacrylate can be positively charged at lower pH, uncharged at intermediate pH and negatively charged at higher pH. Without wishing to limit this invention to a specific theory it is generally believed that the appearance of charges in a polymer chain makes such polymer more hydrophilic and less hydrophobic and vice versa. The disappearance of charges makes the polymer more hydrophobic and less hydrophilic. Also, in general, the more hydrophilic the polymers are the more water-soluble they are. In contrast, the more hydrophobic the polymers are the less water-soluble they are.

### Hydrophobic Polymers and Polymer Blocks:

Examples of hydrophobic polymers or blocks include but are not limited to polymers comprising units deriving from monomers being: alkylene oxide other than polyethylene oxide, such as propylene oxide or butylene oxide, esters of acrylic acid and of methacrylic acid with hydrogenated or fluorinated C₁-C₁₂ alcohols, vinyl nitrites having from 3 to 12 carbon atoms, carboxylic acid vinyl esters, vinyl halides, vinylamine amides, unsaturated ethylenic monomers comprising a secondary, or tertiary amino group, or unsaturated ethylenic monomers comprising a heterocyclic group comprising nitrogen, or styrene. Examples of preferred hydrophobic blocks include polymers comprising units deriving from monomers including: methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate, acrylonitrile, methacrylonitrile, vinyl acetate, vinyl versatate, vinyl propionate vinylformamide, vinylacetamide, vinylpyridines, vinylimidazole, aminoalkyl (meth)acrylates, aminoalkyl(meth)acrylamides, dimethylaminoethyl acrylate, dimethylaminoethyl methacrylate, di-tert-butylaminoethyl acrylate, di-tert-butylaminoethyl methacrylate, dimethylaminoethylacrylamide or dimethylaminoethyl-methacrylamide. The hydrophobic polymers and polymer blocks include poly(.beta.-benzyl L-aspartate), poly(.gamma.-benzyl L-glutamate), poly(beta.-substituted aspartate), poly(.gamma.-substituted glutamate), poly(L-leucine), poly(L-valine), poly(L-phenylalanine), hydrophobic polyamino acids, polystyrene, polyalkylmethacrylate, polyalkylacrylate, polymethacrylamide, polyacrylamide, polyamides, polyesters (such as polylactic acid), polyalkylene oxide other than polyethylene oxide, such as polypropylene oxide) (also called polypropylene glycol or polyoxypropylene), and hydrophobic polyolefins. The hydrophobic polymers or polymer blocks can be either homopolymers or copolymers containing more than one type of monomeric units including a combination of hydrophobic units with at least one other type of units including anionic units, cationic units, zwitterionic units, or hydrophilic nonionic units. Without limiting the generality of this invention it is preferred that the portion of the non-hydrophobic units is relatively low so that the polymer or polymer block remains largely hydrophobic in nature. The hydrophobic polymers containing small number of ionic groups are called ionomers. The hydrophobic polymers and polymer blocks useful in the present invention can also contain ionizable groups and repeating units that are uncharged and hydrophobic at certain environmental conditions, including the conditions at which the pesticidal compositions are prepared, diluted with water for application, or after application in the environment on the plant, soil and the like.

### Hydrophilic-Hydrophobic Block Copolymers:

Examples of block copolymer containing hydrophilic and hydrophobic blocks include but are not limited to polyethylene oxide-polystyrene block copolymer, polyethylene oxide-polybutadiene block copolymer, polyethylene oxide-polyisoprene block copolymer, polyethylene oxide-polypropylene block copolymer, polyethylene oxide-polyethylene block copolymer, polyethylene oxide-poly(β-benzylaspartate) block copolymer, polyethylene oxide-poly(γ-benzylglutamate) block copolymer, polyethylene oxide-poly(alanine) block copolymer, polyethylene oxide-poly(phenylalanine) block copolymer, polyethylene oxide-poly(leucine) block copolymer, polyethylene oxide-poly(isoleucine) block copolymer, polyethylene oxide-poly(valine) block copolymer, polyacrylic acid-polystyrene block copolymer, polyacrylic acid-polybutadiene block copolymer, polyacrylic acid-polyisoprene block copolymer, polyacrylic acid-polypropylene block copolymer, polyacrylic acid-polyethylene block copolymer, polyacrylic acid-poly(β-benzylaspartate) block copolymer, polyacrylic acid-poly(γ-benzylglutamate) block copolymer, polyacrylic acid-poly(alanine) block copolymer, polyacrylic acid-poly(phenylalanine) block copolymer, polyacrylic acid-poly(leucine) block copolymer, polyacrylic acid-poly(isoleucine) block copolymer, polyacrylic acid-poly(valine) block copolymer, polymethacrylic acid-polystyrene block copolymer, polymethacrylic acid-polybutadiene block copolymer, polymethacrylic acid-polyisoprene block copolymer, polymethacrylic acid-polypropylene block copolymer, polymethacrylic acid-polyethylene block copolymer, polymethacrylic acid-poly(β-benzylaspartate) block copolymer, polymethacrylic acid-poly(γ-benzylglutamate) block copolymer, polymethacrylic acid-poly(alanine) block copolymer, polymethacrylic acid-poly(phenylalanine) block copolymer, polymethacrylic acid-poly(leucine) block copolymer, polymethacrylic acid-poly(isoleucine) block copolymer, polymethacrylic acid-poly(valine) block copolymer, poly(N-vinylpyrrolidone)-polystyrene block copolymer, poly(N-vinylpyrrolidone)-polybutadiene block copolymer, poly(N-vinylpyrrolidone)-polyisoprene block copolymer, poly(N-vinylpyrrolidone)-polypropylene block copolymer, poly(N-vinylpyrrolidone)-polyethylene block copolymer, poly(N-vinylpyrrolidone)-poly(β-benzylaspartate) block copolymer, poly(N-vinylpyrrolidone)-poly(γ-benzylglutamate) block copolymer, poly(N-vinylpyrrolidone)-poly(alanine) block copolymer, poly(N-vinylpyrrolidone)-poly(phenylalanine) block copolymer, poly(N-vinylpyrrolidone)-poly(leucine) block copolymer, poly(N-vinylpyrrolidone)-poly(isoleucine) block copolymer, poly(N-vinylpyrrolidone)-poly(valine) block copolymer, poly(aspartic acid)-polystyrene block copolymer, poly(aspartic acid)-polybutadiene block copolymer, poly(aspartic acid)-polyisoprene block copolymer, poly(aspartic acid)-polypropylene block copolymer, poly(aspartic acid) polyethylene block copolymer, poly(aspartic acid)-poly(β-benzylaspartate) block copolymer, poly(aspartic acid)-poly(γ-benzylglutamate) block copolymer, poly(aspartic acid)-poly(alanine) block copolymer, poly(aspartic acid)-poly(phenylalanine) block copolymer, poly(aspartic acid)-poly(leucine) block copolymer, poly(aspartic acid)-poly(isoleucine) block copolymer, poly(aspartic acid)-poly(valine) block copolymer, poly(glutamic acid)-polystyrene block copolymer, poly(glutamic acid)-polybutadiene block copolymer, poly(glutamic acid)-polyisoprene block copolymer, poly(glutamic acid)-polypropylene block copolymer, poly(glutamic acid)-polyethylene block copolymer, poly(glutamic acid)-poly(β-benzylaspartate) block copolymer, poly(glutamic acid)-poly(γ-benzylglutamate) block copolymer, poly(glutamic acid)-poly(alanine) block copolymer, poly(glutamic acid)-poly(phenylalanine) block copolymer, poly(glutamic acid)-poly(leucine) block copolymer, poly(glutamic acid)-poly(isoleucine) block copolymer and poly(glutamic acid)-poly(valine) block copolymer. Examples of hydrophilic-hydrophobic block copolymers include copolymers that contain ionizable groups and repeating units that are uncharged and hydrophobic at certain environmental conditions. For example, the poly[2-(methacryloyloxy)ethyl phosphorylcholine-block-2-(diisopropylamino)ethyl methacrylate copolymer is pH sensitive: both blocks are relatively hydrophilic at pH 2 but at the environmental pH about 6 and higher the 2-(diisopropylamino)ethyl methacrylate block becomes relatively hydrophobic, while the poly[2-(methacryloyloxy)ethyl phosphorylcholine block remains hydrophilic.

The block copolymers useful in this invention can have different configuration of the polymer chain including different arrangements of the blocks, such as linear block copolymers, graft copolymers, star block copolymers, dendritic block copolymers and the like. The hydrophilic and hydrophobic blocks independently of each other can be linear polymers, randomly branched polymers, block copolymers, graft copolymers, star polymers, star block copolymers, dendrimers or have other architectures, including combinations of the above-listed structures. The degree of polymerization of the hydrophilic and hydrophobic blocks independently from each other is between about 3 to about 100,000. More preferably, the degree of polymerization is between about 5 and about 10,000, still more preferably, between about 10 and about 1,000.

### Block Copolymers of Ethylene Oxide and Other Alkylene Oxides:

In one preferred embodiment of the present invention the amphiphilic block copolymers that comprise at least one nonionic hydrophilic block and at least one hydrophobic block are used as amphiphilic compounds. Such copolymer may have different number of the repeating units of in each of the blocks as well as different configuration of the polymer chain, including number, orientation and sequence of the polymer blocks. Other alkylene oxides include for example, propylene oxide, butylene oxide, cyclohexene oxide, and styrene oxide. Without wishing to limit the generality of this invention the following section describes, as an example, one class of such amphiphilic compounds the block copolymers of ethylene oxide and propylene oxide having the formulas:

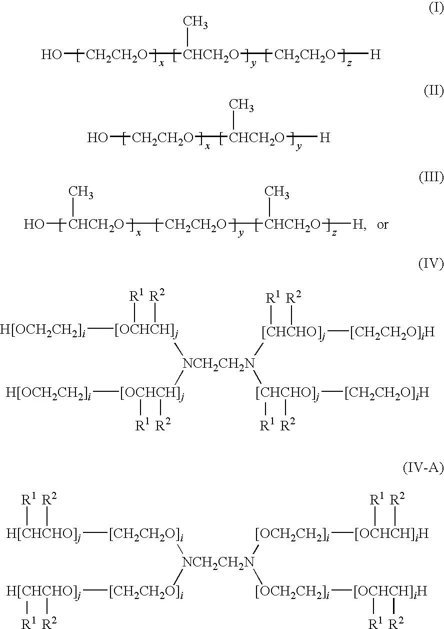

in which x, y, z, i and j have values from about 2 to about 800, preferably from about 5 to about 200, more preferably from about 5 to about 80, and wherein for each R¹, R² pair, one is hydrogen and the other is a methyl group.

Formulas (I) through (III) are oversimplified in that, in practice, the orientation of the isopropylene radicals within the polypropylene oxide block can be random or regular. This is indicated in formula (IV), which is more complete. Such polyethylene oxide-polypropylene oxide compounds have been described by Santon, Am. Perfumer Cosmet. 72(4):54-58 (1958); Schmolka, Loc. cit. 82(7):25 (1967); Schick, Non-ionic Surfactants, pp. 300-371 (Dekker, NY, 1967). A number of such compounds are commercially available under such generic trade names as “poloxamers”, “pluronics” and “synperonics.” Pluronic polymers within the B-A-B formula are often referred to as “reversed” pluronics, “pluronic R” or “meroxapol”. The “polyoxamine” polymer of formula (IV) is available from BASF (Wyandotte, Mich.) under the tradename Tetronic™. The order of the polyethylene oxide and polypropylene oxide blocks represented in formula (IV) can be reversed (formula (IV-A)), creating Tetronic R™, also available from BASF. See, Schmolka, J. Am. Oil Soc., 59:110 (1979). Polyethylene oxide-polypropylene oxide block copolymers can also be designed with hydrophilic blocks comprising a random mix of ethylene oxide and propylene oxide repeating units. To maintain the hydrophilic character of the block, ethylene oxide will predominate. Similarly, the hydrophobic block can be a mixture of ethylene oxide and propylene oxide repeating units. Such block copolymers are available from BASF under the trade name Pluradot™.

The diamine-linked pluronic of formula (IV) can also be a member of the family of diamine-linked polyethylene oxide-polypropylene oxide polymers of formula:

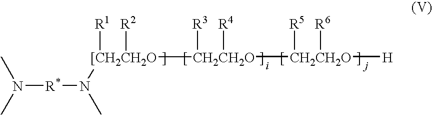

wherein the dashed lines represent symmetrical copies of the polyether extending off the second nitrogen, R* is an alkylene of 2 to 6 carbons, a cycloalkylene of 5 to 8 carbons or phenylene, for R¹ and R², either (a) both are hydrogen or (b) one is hydrogen and the other is methyl, for R³ and R⁴ either (a) both are hydrogen or (b) one is hydrogen and the other is methyl, if both of R³ and R⁴ are hydrogen, then one R⁵ and R⁶ is hydrogen and the other is methyl, and if one of R³ and R⁴ is methyl, then both of R⁵ and R⁶ are hydrogen.

Those of ordinary skill in the art will recognize, in light of the discussion herein, that even when the practice of the invention is confined for example, to polyethylene oxide-polypropylene oxide compounds, the above exemplary formulas are too confining. Thus, the units making up the first block need not consist solely of ethylene oxide. Similarly, not all of the second type block need consist solely of propylene oxide units. Instead, the blocks can incorporate monomers other than those defined in formulas (I)-(V), so long as the parameters of this first embodiment are maintained. Thus, in the simplest of examples, at least one of the monomers in the hydrophilic block might be substituted with a side chain group as previously described.

In addition, the block copolymers may be end capped with ionic groups, such as sulfate and phosphate. Preferred polyethylene oxide-polypropylene oxide compounds include triblock poly(ethylene oxide)-poly(propylene oxide)-poly(ethylene oxide) copolymers end-capped with phosphate groups available from Clariant Corporation.

In the amphiphilic block copolymers described by formulae (I-V) the polypropylene oxide block has a molecular weight of approximately 100 to approximately 20,000 Daltons, preferably between approximately 900 and approximately 15,000 Daltons, more preferably between approximately 1,500 Daltons and approximately 10,000 Daltons, still more preferably between approximately 2,000 Daltons to approximately 4,500 Daltons. The polyethylene oxide block independently of the polypropylene oxide block has a molecular weight of approximately 100 to approximately 30,000 Daltons.

The formulas (I) through (IV) exemplify the amphiphilic block copolymers with different configuration of the polymer chain. Numerous such copolymers having different structures of the hydrophilic or hydrophobic polymer blocks or different configurations of the polymer chain are available and can be used as amphiphilic compounds to prepare pesticidal compositions of this invention. Such amphiphilic compounds contain various hydrophilic and hydrophobic polymer blocks, as exemplified above, which can be cationic, anionic, zwitterionic, or nonionic.

In one aspect of this invention, mixtures of polyethylene oxide-polyoxyalkylene oxide block copolymers are preferred. In this case the preferred microblend compositions comprise at least one block copolymer with polyethylene oxide content at or above 50% wt., which may serve as a first amphiphilic compound, and at least one block copolymer with polyethylene oxide content less than 50% wt., which may serve as a second compound. In the situation where both block copolymers in the mixture are polyethylene oxide-polypropylene oxide copolymers, specifically PEO-PPO-PEO triblock copolymers, it is preferred that one of the copolymers has a polyethylene oxide content of greater or equal to 70% and the other has a polyethylene oxide content of between about 10% and about 50%, preferably between about 15% and about 30%, and still more preferably between about 25% and about 30%.

If the first compound of the composition of this invention is an amphiphilic copolymer of formula (1) and the second compound is an amphiphilic polyoxyethylated surfactant, then the second compound typically has a Cloud Point of at least 25° C., where the Cloud Point is determined by the German Standard Method (DIN 53917). However, nonionic amphiphilic surfactants, with any value of Cloud Point, including less than 25° C., can be used as part of the composition in addition to the first and second compound.

### Amphiphilic Surfactants

The first amphiphilic compound in this invention may be an amphiphilic surfactant. Independently from the first compound, the second compound may be an amphiphilic surfactant. If the first compound of the composition of this invention is a nonionic amphiphilic surfactant and the second compound is a nonionic amphiphilic surfactant, then both the first compound and the second compound have a Cloud Point of at least 25° C., where the Cloud Point is determined by the German Standard Method (DIN 53917). However, nonionic amphiphilic surfactants, with any value of Cloud Point, including less than 25° C., can be used as part of the composition in addition to the first and second compound.

The surfactants may be nonionic, cationic, or anionic (e.g., salts of fatty acids). The amphiphilic surfactant may be polymeric and non-polymeric In one preferred embodiment, the surfactants are non-polymeric. The functional properties of amphiphilic surfactants can be modified by changing the chemical structure of the hydrophobic moiety and structure of the hydrophilic moiety linked to the hydrophobic moiety, such as the length or extent of ethoxylation, and hence, the HLB. Suitable surfactants also include those containing more than one head group, known as Gemini surfactants.

The principal classes of surfactants useful in this invention include but are not limited to alkylphenol ethoxylates, alkanol ethoxylates, alkylamine ethoxylates, sorbitan esters and their ethoxylates, castor oil ethoxylates, ethylene oxide/propylene oxide block copolymers, alkanol/propylene oxide/ethylene oxide copolymers.

Examples of surfactants available in the pesticidal formulation art and which may be used in compositions according to this invention include, but are not limited to alkoxylated triglycerides, alkyl phenol ethoxylates, ethoxylated fatty alcohols, alkoxylated fatty acids, alkoxylated alkyl polyglycosides, alkoxylated fatty amines, fatty acid polyethylene glycol esters, polyol ethoxylate esters, sorbitan esters, and the like. For example, the following amphiphilic surfactants with various lengths of ethylene oxide and propylene oxide moieties are available for example from Cognis: ethoxylated castor oil (Agnique CSO), ethoxylated soybean oil (Agnique SBO), alkoxylated rapeseed oil (Agnique RSO), ethoxylated octylphenol and nonylphenol (Agnique Op and Agnique NP), ethoxylated C12-14 alcohol, C12-18 alcohol, C6-12 alcohol, C16-18 alcohol, C9-11 alcohol, oleyl-cetyl alcohol, decyl alcohol, iso-decyl alcohol, tri-decyl alcohol, octyl alcohol, stearyl alcohol (Agnique FOH); ethoxylated C18 oleic acid (Agnique FAC); ethoxylated Coco amine; ethoxylated oleyl amine; ethoxylated tallow amine; ethoxylated C8 methyl ester; ethoxylated tristyrylphenols (Aqnique TSP).

Suitable nonionic surfactants include, but are not limited to the compounds formed by ethoxylation of long chain alcohols and alkylphenols (including sorbitan and other mono-, di- and polysaccharides) or long chain aliphatic amines and diamines. Preferably, the number of ethylene oxide units ranges from 3 to about 50.

Preferred amphiphilic surfactants include n-alkylphenyl polyoxyethylene ethers, n-alkyl polyoxyethylene ethers (e.g., Triton™), sorbitan esters (e.g. Span™), polyglycol ether surfactants (Tergitol™), polyoxy-ethylenesorbitan (e.g., Tween™), polysorbates, polyoxyethylated glycol monoethers (e.g., Brij™), lubrol, polyoxyethylated fluorosurfactants (e.g. ZONYL® fluorosurfactants available from DuPont), ABC-type block copolymers (such as Synperonic NPE and Atlas G series from Uniqema), polyarylphenolethoxylates, with various anions including sulphate and phosphate.

Particularly preferred are polyoxyethylated aromatic surfactants, such as tristyryl phenols such as SOPROPHOR™ surfactants available from Rhodia. Of these, compounds containing sulphate and phosphate groups are preferred. Examples of Soprophors available commercially include; SOPROPHOR 4D 384 SOPROPHOR 3D-33, SOPROPHOR 3D33 LN, SOPROPHOR 796/P, SOPROPHOR BSU, SOPROPHOR CY 8, SOPROPHOR FLK, SOPROPHOR S/40-FLAKE, SOPROPHOR TS/54, SOPROPHOR S25/80, SOPROPHOR S25, SOPROPHOR TS54, SOPROPHOR TS10, and SOPROPHOR TS29. SOPROPHOR 4D 384 (2,4,6-Tris[1-(phenyl)ethyl]phenyl-omega-hydroxypoly(oxyethylene)sulphate) has the following structure:

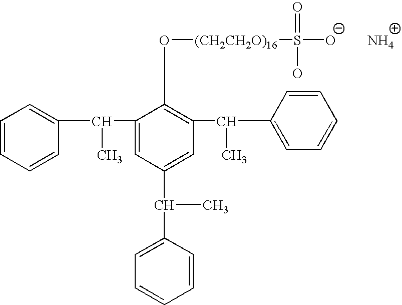

Other Soprophors have similar structures to the structure shown above, except that the length of the ethylene oxide chain varies from about 3 to about 50 ethylene oxide repeating units and the sulphate group may be replaced with a phosphate group.

### Microblend Preparation

The microblends are prepared by combining the amphiphilic compound, optionally at least one second compound and the pesticide and stirring for a suitable period of time. It is possible to use mixtures of more than one second compound, either from the same groups listed above or from different groups. The components need to be intimately mixed in order to form the microblend. In one preferred approach the components are simply melted together and stirred to form the microblend. In another preferred approach the components are dissolved in a common, or compatible, organic solvent and stirred to form the microblend. The solvent is then be evaporated to isolate the microblend.

It is also preferred that the second compound is a considerable component of the composition, more that 0.1% wt. The amount of second compound in the composition is preferably in the range of about 0.1% to 90% by weight of the composition, more preferably from greater than 10% to 50%, still more preferably from greater than 10% to 30%. The ratio of the first amphiphilic compound to the second compound by weight is in the range of 1:1 to 20:1, preferably 1:1 to 10:1. If the second compound is a non-polymeric surfactant as defined herein, it must be present in the composition in an amount of at least 1% of the weight of the first component and preferably at least 10% by weight of the first component. In liquid compositions of the preferred embodiment containing added water-miscible organic solvents, such non-polymeric surfactant must be present in an amount of at least 10% by weight of the first component. If a water-miscible solvent is added to the composition, it is preferably added in ratio of water:solvent of greater than 1:2.

The stability of the microblend in the final aqueous dispersion for the durations described above is critical for the use of the present pesticidal compositions. It was discovered that when the pesticidal compositions are obtained by blending an amphiphilic compound and a pesticide, which serves as the second compound, the amount of the pesticide should be kept relatively small to maintain the preferred particle size, avoid precipitation of the active ingredients and/or decomposition of the microblend dispersion for the defined periods. In such two-component blends the amount of the pesticide is preferably less than an about 50 percent by weight of the blend, more preferably less than about 30 percent, still more preferably less than about 20 percent, still more preferably less than about 10 percent. If the second compound in the microblend is any one of a homopolymer or random copolymer, an amphiphilic compound, a hydrophobic molecule other than the pesticide, and a hydrophobic molecule linked to a hydrophilic polymer, then generally higher amounts of the pesticides can be used. Still, it is preferred that the amount of a pesticide in such compositions, is not more than 60 percent by weight, or preferably less that 30 percent. The hydrophilic-hydrophobic block copolymers and nonionic amphiphilic surfactants are preferred as the second compounds in the pesticidal compositions of this invention.

The microblends may be disrupted by small amounts of water, and therefore they should not contain water as an added component or solvent unless water is mixed with a water-soluble compound. Specifically, the water content in microblends should be less than 10% wt, preferably less than 1% wt, still more preferably less than 0.1%, yet still more preferably no water is added. It is recognized that the components used to prepare microblends, including the first amphiphilic compound, the second compound, the active ingredients, the surfactants and the like may be hydrated. For example, water may be tightly or intrinsically bound to surfactants, polyethylene glycol, polypropylene glycol and the like. Such bound hydration water may not disturb the microblends. The aqueous solutions or colloidal dispersions of the first amphiphilic compound, the second compound or the pesticide should not be used to prepare microblends unless water is then removed by any method available in the art.

The water soluble polymeric or oligomeric compounds, such as ethylene glycol or propylene glycol polymers or oligomers, or copolymers of the ethyleneglycol and propyleneglycol can be also added at any stage to prepare the suitable formulations. Such compounds can be added to dissolve one, several or all components of the microblend, added before these components or at the stage of mixing of the microblend components or added after the microblend is formed.

It is preferred that addition of water immiscible solvents is avoided, or the amount of such solvents is kept low, since considerable amounts of such solvents may disrupt the intimate contact between the components of microblend, decrease the stability of the microblends, increase the particle size or otherwise disrupt the microblend compositions. However, if the second compound is an aromatic compound or a hydrophobic polymer, the composition may contain a water-immiscible solvent. The water-immiscible solvent preferably has a solubility in water of less than 10 g/L. In addition, gels may also be formed through the addition of water-immiscible solvents in these compositions.

Without limiting the generality of the invention to a specific application procedure, before the application the microblends may be diluted in an aqueous environment forming an aqueous dispersion. In an alternative preparation, the microblend is formed in situ in an aqueous environment by combining the first amphiphilic compound and the second compound/pesticide and stirring for a sufficient period of time. The pesticidal compositions of this invention are prepared by combining one or several components of the microblend in different order and/or in different solvents, removing the solvent, and then mixing them with water to form the aqueous dispersions. For example, a solution of the first amphiphilic compound can be combined with a solution of the second compound and stirred for a time sufficient to form the microblend, followed by evaporation of solvent. Since cross-linked polymer networks are not readily blended with each other, they should be excluded; however, the compounds of this invention may contain polymers having certain amount of chains connected with each other through cross-links, if such polymers can form the microblend.

The dispersions formed after dilution may not be necessarily thermodynamically stable. However, following the dilution in water the dispersion should retain the particle size in the nanoscale range for at least about 12 hours, more preferably 24 hours, still more preferably about 48 hours, still more preferably several days. Preferably, the particle size of the small micelles formed after dilution ranges from about 10 to 300 nm, more preferably about 15 to 200 nm, still more preferably about 20 to 100 nm. A gradual increase in particle size over time does not denote lack of stability so long as the average particle size remains in the nanoscale range. Preferably, the compositions of the invention should not be diluted to the extent that there are no particles present as a result of the dilution. As will be appreciated by those skilled in the art this particle size range may be different in an actual use environment where a number of environmental factors (temperature, pH, etc) and the presence of other components (trace metals, minerals such as calcium carbonate naturally present in water, added micro- or nanoparticles of different origin, colloidal metals, metal oxides, or hydroxides, etc) may affect the particle size measurement.

In one aspect, this invention relates to concentrated microblend compositions, which (a) comprise an amphiphilic compound and a pesticide, (b) can be one of liquid, paste, solid, powder, or gel, (c) after dilution in water readily disperses and forms aqueous dispersion with particles of nanoscale range, and (d) such dispersion remains stable for the period necessary for the application. As shown in the examples presented below, such pesticidal compositions can be prepared using various amphiphilic compounds and other components of the microblend described in the present invention.

One major advantage of the microblend compositions is that these compositions can be formulated as dust formulations, water dispersible granules, tablets, wettable powders, or similar dry formulations that are used in the pesticidal art. Without limiting the generality of this invention to a specific formulation type or procedure, conventional pesticidal techniques may be used to prepare such pesticidal formulations. For example, water dispersible granules or powders can be obtained using pan granulation, high speed mixing agglomeration, extrusion granulation, fluid bed granulation, fluid bed spray granulation, and spray drying. Conventional excipients used in the formulation art may be added to facilitate the formulation processes. The formulated microblends are easy to pour and measure, exhibit fast dispersion in spray tank, and have extended shelf lives.

In another aspect of the invention, the above described microblends are employed in compositions suitable for application in methods that are conventionally employed in the pesticidal art. Thus, for example, the microblend may be in the form of water dispersible granules, suspension concentrates, and soluble liquid concentrates as discussed above, combined with water and sprayed onto a site where pests are present or are expected to be present. Conventional formulation techniques, adjuvants, etc. which are well known to those skilled in the art of pesticidal formulation, may be used. The dispersion should remain stable for at least 24 hours and up to several days.

In a further aspect of the invention, the above described compositions are employed in methods that are conventionally employed in the pesticidal art. Thus, for example, the composition may be combined with water and sprayed onto a site where pests are present or are expected to be present.

In addition, the above described compositions may be employed in the form of a micellar solution, comprising normal or inverted micelles, an oil-in-water microemulsion, also called a “water external” microemulsion, a water-in-oil microemulsion, also called an “oil external” microemulsion or a molecular cosolution. The compositions may also be formulated as gels, containing liquid crystals, and may contain lamella, cylindrical, or spherical structures.

The concentrates may be applied in an undiluted state as dusts, powders, and granules. Such formulations may contain conventional additives well known to one of ordinary skill in the art, e.g., carriers, such as solid carriers. Carriers include Fuller's earth, kaolin clays, silicas, and other highly absorbent, readily wet inorganic diluents. When formulated as dusts, the pesticide compositions of the invention are admixed with finely divided solids such as talc, natural clays, kieselguhr, flours such as walnut shell and cottonseed flours, and other organic and inorganic solids which act as dispersants, densifiers, and carriers for the pesticide.

The microblend compositions may be packaged using packaging commonly employed in pesticidal art. For example, these compositions once formulated as dry, liquid or gel formulations and not containing added water, may be packaged in water-soluble film bags. The film is usually made of polyvinyl alcohol.

An important aspect of this invention is that pesticidal microblends can be blended with one or more active ingredients, or with different other chemical compounds that can improve the biological activity of pesticide or pesticidal formulation, decrease metabolism, decrease toxicity, increase chemical or photochemical stability. Examples include addition of UV-protective compounds, metabolic inhibitors, and the like. By intrinsically mixing pesticides with other components in a microblend composition, activity (for example, the activity and stability of the pesticides) can be increased, while the toxicity and environmental damage can be decreased.

The compositions according to this invention may additionally comprise safeners, such as, for example, benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, and oxabetrinil.

The compositions may additionally comprise cationic and anionic surfactants. Examples of suitable cationic amphiphilic surfactants include but are not limited to dialkyl (C9-C18) dimethyl ammonium chloride, methyl ethoxy(3-15) alkyl (C8-C18) ammonium chloride, mono and di-alkyl (C8-C18) methylated ammonium chloride, and the like. Examples of suitable anionic amphiphilic surfactants include, but are not limited to: fatty alcohol ether sulfates, alkyl naphthalene sulfonates, disopropyl naphthalene sulfonates, disopropyl naphthalene sulfonate, alkylsulfates, alkylbenzene sulfonates, naphthalene sulfonate condensates, naphthalene sulfonate-formaldehyde condensate, and the like. It is preferred that the amount of such anionic or cationic surfactants is maintained low compared to other components of the pesticidal composition but sufficient to enhance the performance of this composition.

Unexpectedly, the pesticidal compositions of the present invention demonstrate superior performance compared to traditional formulations accepted in agricultural practices of the active ingredients. Surprisingly, it was discovered that the microblend compositions increase the biological activity of the pesticidal formulation and therefore result in a more efficacious pest control. They can increase bioavailability, including oral bioavailability or topical bioavailability of the pesticides, for the targeted pests and therefore result in a more efficacious pest control. Surprisingly, they can also increase acquisition of the effective dose of the pesticide by a pest, for example, by decreasing the avoidance of the pesticide by a pest or decreasing regurgitation of the acquired dose, and therefore result in a more efficacious pest control.

In addition these microblend compositions can change the pharmacokinetic behavior of the pesticide in the target organisms, resulting in superior activity and a more efficacious pest control. In another aspect of the invention, the rate of killing of the target pests with the microblends compositions is increased, also resulting in a more efficacious pest control. Such pesticidal compositions work faster, providing better protection and less damage for protected plants. Surprisingly, the microblend compositions can also decrease the damage to the plant at lower doses, compared to traditional formulations of the same active ingredients accepted in agricultural practices. For example, the percent of the leaves consumed or damaged by pest is decreased.

In yet another aspect of this invention, the microblend compositions can change the soil mobility of the pesticides, resulting in a better control of soil pests. Without limiting this invention to a specific theory or application practice, as an example, the pesticidal compositions can increase soil mobility of the pesticides, such as lipophilic active ingredients, and enhance the control of the pests at the required depth. In another example, the microblend compositions can decrease the mobility of the pesticide in the soil, for example, to prevent penetration of the active ingredients into ground water, or to increase the retention of the active ingredients at the surface of the plant. This may be achieved by changing the hydrophobicity and hydrophilicity of the components of the components of the microblend, or by adding charged components such as cationic or anionic amphiphilic compounds, or cationic or anionic surfactants.

In yet another aspect of this invention, the microblend compositions can enhance the entry of the pesticide into a plant and, for example, increase systemicity of even non-systemic active ingredients through the root, shoot or leaf uptake. The microblend compositions of the present invention allow reduced amounts of pesticides to be applied compared to traditional formulations accepted in agricultural practices of the same or other active ingredients. Without limiting this invention to specific application procedures, the reduced amount of pesticides can be achieved by using lower concentration of the active ingredient in the pesticidal formulation or by reducing the amount of the formulation applied, or by combination of both. As a result of these unexpected discoveries, the pesticidal compositions of the present invention provide considerable economical and environmental benefits. The pesticidal composition of the present invention can be used to incorporate a very broad range of the active ingredients, including those that cannot be formulated by traditional formulation methods, or those which, when formulated using traditional methods, do not provide adequate benefits for pest control.

In order to describe the invention in more detail, the following examples are set forth: Examples 1 and 2 demonstrate the preparation of a microblend in which the microblend is formed in situ in an aqueous environment. The remaining examples demonstrate the preparation of a microblend (Examples 3-49) and the testing of the pesticide compositions (Examples 50-53).

### Example 1

### A Microblend of Bifenthrin with Nonionic Block Copolymers

The hydrophilic-hydrophobic polyethylene oxide-polypropylene oxide block copolymers, with various lengths of the ethylene oxide (EO) and propylene oxide (PO) blocks, EOₙ-POₘ-EOₙ, were used in this example as amphiphilic compounds:Pluronic P85 (n=26, m=40), Pluronic L61 (n=4, m=31), and Pluronic F127 (n=100, m=65). A powder of crude Bifenthrin (n-octanol partition coefficient, logP>6) was mixed with 1.5 ml of the copolymer solution in phosphate buffered saline (pH 7.4, 0.15 M NaCl). Compositions of the final mixtures were as shown in Table 1.

TABLE 1

| | | | Pluronic L61/ |
|---|---|---|---|
| | | | Pluronic F127 |
| Composition | Pluronic P85 | Pluronic P85 | (1:8 mixture) |
| Total copolymer | 1.0 | 3.0 | 2.25 |
| concentration (wt %) | | | |
| Bifenthrin (mg) | 5.4 | 5.5 | 5.2 |

The suspensions were shaken for 40 h at room temperature followed by centrifugation for 10 min at 13,000 rpm. The concentration of Bifenthrin in the supernatants was determined by UV-spectroscopy. For this purpose, standard solutions containing from 0 to 0.58 mg/ml of Bifenthrin in ethanol were prepared using a stock solution of Bifenthrin in acetonitrile with concentration of 8.7 mg/ml. These solutions were used to obtain a calibration curve by measuring an absorbance at 260 nm using Perkin-Elmer Lambda 25 spectrophotometer. The resulting calibration curve for Bifenthrin was as follows: Abs=0.0125+4.3694 C_{Bifenthrin}, r²=0.999. The amounts of Bifenthrin solubilized in Pluronic P85 dispersion were 0.032 mg/ml and 0.073 mg/ml for 1% and 3% Pluronic P85 solutions, respectively. The amount of Bifenthrin solubilized in the mixture of Pluronic L61 and Pluronic F127 copolymers was 0.22 mg/ml. The sizes of the particles in the formed dispersions were determined by dynamic light scattering using “ZetaPlus” Zeta Potential Analyzer (Brookhaven Instrument Co.) with 30 mV solid state laser operated at the wavelength of 635 nm. The measurements in the dispersions containing Bifenthrin and Pluronic P85 revealed the formation of particles with the diameters over 400 nm. The size of the particles in the dispersions of Pluronic L61 and Pluronic F127 containing Bifenthrin was 34 nm. Therefore, the dispersion containing the mixture of two amphiphilic compounds with different lengths of the hydrophilic and hydrophobic moieties incorporates a greater amount of pesticide and form smaller particles than the dispersion containing one amphiphilic compound.

### Example 2

### A Microblend of Bifenthrin with Nonionic Block Copolymer Mixtures

The mixtures of polyethylene oxide-polypropylene oxide block copolymers, with different lengths of the EO and PO blocks, EOₙ-POₘ-EOₙ, were used in this example as amphiphilic compounds:Pluronic P123 (n=20, m=69), Pluronic L121 (n=5, m=68), and Pluronic F127 (n=100, m=65). The Pluronic P123 and Pluronic F127 were mixed in water or in phosphate buffered saline (pH 7.4, 0.15 M NaCl) (PBS). The stable mixture of Pluronic L121 and Pluronic F127 containing 0.1% of each copolymer was prepared in water at elevated temperature as described before (J Controlled Rel. 2004, 94, 411-422). A fine powder of Bifenthrin, which contained particles of size below 425 mkm, was mixed with 1 ml of the solutions of the copolymer mixtures. The compositions of the final mixtures were as shown in Table 2.

TABLE 2

| | Pluronic P123/ | Pluronic P123/ | Pluronic L121/ |
|---|---|---|---|
| Composition | Pluronic F127 | Pluronic F127 | Pluronic F127 |
| Composition of | 1:1 | 1:1 | 1:1 |
| Pluronic mixture | | | |
| Total copolymer | 2.0 | 2.0 | 0.2 |
| concentration (% wt) | | | |
| Solvent | Water | PBS | Water |
| Bifenthrin (mg) | 3.1 | 3.2 | 3.1 |

After addition of Bifenthrin the suspensions were formed, which were then shaken for 96 hours at room temperature followed by centrifugation for 10 min at 13,000 rpm. The concentration of Bifenthrin in the supernatants and the size of the particles were determined as described in Example 1. The concentration of Bifenthrin solubilized in the dispersions (mg/ml) and the loaded amount of Bifenthrin (percent by weight of the blend with amphiphilic compounds) are presented in Table 3.

TABLE 3

| | Pluronic P123/ | Pluronic P123/ | Pluronic L121/ |
|---|---|---|---|
| Composition | Pluronic F127 | PluronicF127 | Pluronic F127 |
| Solvent | Water | PBS | Water |
| Bifenthrin | 0.55 | 0.61 | 0.22 |
| concentration (mg/ml) | | | |
| Loading (% w/w) | 2.75 | 3.05 | 10.9 |
| Particle size (nm) | 31 | 57 | 107 |

Therefore, the dispersions containing from about 2% to about 10% of pesticide by weight of the blend with amphiphilic compounds, having small particle size can be formed in situ, however, a long time of mixing is required.

### Example 3

### A Microblend of Bifenthrin with Nonionic Block Copolymer Melts

Microblends of Bifenthrin were prepared using melts of Pluronic block copolymers mixtures. The mixtures of polyethylene oxide-polypropylene oxide block copolymers, with different lengths of the EO and PO blocks, EOₙ-POₘ-EOₙ, were used in this example as amphiphilic compounds:Pluronic P123 (n=20, m=69), and Pluronic F127 (n=100, m=65). Briefly, 43.7 mg of the first amphiphilic compound, Pluronic F127 were added to a round bottom flask and melted at 85° C. in water bath upon rotation. The 43.7 mg of the second amphiphilic compound, Pluronic P123 in 0.65 ml of acetonitrile/methanol mixture (2:1 v/v) were added to the melt, thoroughly mixed upon rotation followed by evaporation of the solvents and traces of water in vacuo. 8.74 mg of Bifenthrin in 87.4 ul of acetonitrile were mixed with the copolymer melt and the solvent was evaporated in vacuo for 30 min. The melted composition was cooled down to room temperature and then hydrated in 8.74 ml of water upon stirring. After 1 hour a slightly opaque aqueous dispersion was formed. The total concentration of Pluronic copolymers in the dispersion was 1%. The size of the copolymer particles was 77 nm as determined by dynamic light scattering using “ZetaPlus” Zeta Potential Analyzer (Brookhaven Instrument Co.). The concentration of Bifenthrin in the microblend was 1 mg/ml as determined by UV-spectroscopy as described in Example 1. The microblend loading capacity with respect to Bifenthrin was 10% w/w (0.1 mg of Bifenthrin per 1 mg of copolymer). No precipitation was observed in the prepared microblend aqueous dispersions for four days. Subsequent measurements showed no change in the size of the microblend loaded with Bifenthrin. Therefore, a stable aqueous dispersion with small particle size can be readily prepared using concentrated microblend melts of a pesticide with amphiphilic compounds.

### Example 4

### A Microblend of Bifenthrin with Nonionic Block Copolymer Melts

42.3 mg of Pluronic F127 and 43 mg of Pluronic P123 were added to a round bottom flask, melted at 85° C. in a water bath and thoroughly mixed upon rotation followed by evaporation of the traces of water in vacuo. 8.5 mg of Bifenthrin in 85 ul of acetonitrile was mixed with the copolymer melt and the solvent was evaporated in vacuo for 30 min. The microblend composition was cooled down to room temperature and then supplemented with 4.5 ml of water and stirred overnight. An opaque dispersion was formed. The total concentration of Pluronic copolymers in the dispersion was 1.9%. Although no visible precipitation of Bifenthrin was observed, the final dispersion was centrifuged for 5 min at 13,000 g. The size of the particles in the resulting dispersion was 102 nm as determined by dynamic light scattering using “ZetaPlus” Zeta Potential Analyzer (Brookhaven Instrument Co.). The concentration of Bifenthrin in the dispersion was 1.82 mg/ml as determined by UV-spectroscopy as described Example 1. The microblend loading capacity with respect to Bifenthrin was 9.63% w/w. The dispersion was stable at least for 30 hours at room temperature. After this period the formation of fine white crystals was observed in the dispersion. Therefore, a stable aqueous dispersion with small particle size was prepared using concentrated microblend melts of a pesticide with amphiphilic compounds.

### Example 5

### A Microblend of Bifenthrin with Nonionic Block Copolymer Melts

3.5 mg of Pluronic F127 were added to a round bottom flask and melted at 85° C. in a water bath upon rotation. 43.5 mg of Pluronic P123 in 0.65 ml of acetonitrile/methanol mixture (2:1 v/v) were added to the melt, thoroughly mixed upon rotation followed by removal of the solvents and traces of water in vacuo. 17.4 mg of Bifenthrin in 174 ul of acetonitrile were mixed with the copolymer blend and the solvent was evaporated in vacuo for 30 min. The copolymers:Bifenthrin ratio was 5:1 by weight. The melted composition was cooled down to room temperature and then dispersed in 8.7 ml of water and stirred overnight. The total concentration of Pluronic copolymers in the mixture was 1%. As a result, a white suspension containing fine crystals of Bifenthrin was formed. The suspension was centrifuged for 10 min at 13,000 rpm. The size of the particles in the supernatant was 88 nm as determined by dynamic light scattering using “ZetaPlus” Zeta Potential Analyzer (Brookhaven Instrument Co.). The concentration of Bifenthrin in the dispersion was 1.09 mg/ml as determined by UV-spectroscopy as described in Example 1. The microblend loading capacity with respect to Bifenthrin was 10.9% w/w. Therefore, a stable aqueous dispersion with small particle size was prepared using concentrated microblend melts of a pesticide with amphiphilic compounds.

### Example 6

### Microblends of Bifenthrin with Nonionic Block Copolymer Melts

Microblends of Bifenthrin were prepared using the melts of the mixtures of polyethylene oxide-polypropylene oxide block copolymers, with different lengths of the EO and PO blocks, EOₙ-POₘ-EOₙ:Pluronic P123 (n=20, m=69), Pluronic L121 (n=5, m=68), and Pluronic F127 (n=100, m=65). Briefly, the defined amount of the first amphiphilic compound, Pluronic F127 was added to a round bottom flask and melted at 85° C. in water bath upon rotation. Then the solution of a second Pluronic copolymer in organic solvent (acetonitrile or methanol) was added to the same flask and the copolymers were thoroughly mixed upon rotation followed by removal of the solvents and traces of water in vacuo. The solutions of Bifenthrin in acetonitrile were mixed with copolymer melts and the solvent was evaporated in vacuo for 30 min. The melted compositions were cooled down to a room temperature and then hydrated in water upon stirring for ca. 16 hours. The compositions of the final mixtures were as shown in Table 4.

TABLE 4

| | Pluronic F127/ | Pluronic F127/ | Pluronic F127/ | PluronicF127/ |
|---|---|---|---|---|
| Composition | Pluronic P123 | Pluronic P123 | Pluronic P85 | Pluronic L121 |
| Composition of | 9:1 | 9:1 | 1:1 | 5:1 |
| Pluronic mixture | | | | |
| Total copolymer | 1.0 | 2.0 | 1.0 | 1.0 |
| concentration (% wt) | | | | |
| Water (ml) | 10 | 5 | 6.6 | 6 |
| Bifenthrin (mg) | 10 | 10 | 6.6 | 6 |

In all cases the formation of white suspensions containing fine crystals of Bifenthrin were observed. The suspensions were centrifuged for 10 min at 13,000 rpm. The concentrations of Bifenthrin in the dispersions, the size of the copolymer particles, as well as the microblend loading capacity with respect to Bifenthrin were determined as described in Example 1. These parameters are presented in Table 5.

TABLE 5

| | Pluronic F127/ | Pluronic F127/ | Pluronic F127/ | PluronicF127/ |
|---|---|---|---|---|
| | Pluronic P123 | Pluronic P123 | Pluronic P85 | Pluronic L121 |
| Composition | (9:1) | (9:1) | (1:1) | (5:1) |
| Total copolymer | 1.0 | 2.0 | 1.0 | 1.0 |
| concentration (% wt) | | | | |
| Bifenthrin (mg/ml) | 0.13 | 0.12 | 0.05 | 0.25 |
| Loading (% w/w) | 1.3 | 0.6 | 0.5 | 2.5 |
| Particle size (nm) | 235 | >700 | 57 | 137 |

By comparing this result with the Experiment 3, one can conclude that the particle size and the loading capacity of the pesticide in microblend aqueous dispersions depend on the composition of the mixture and the chemical structure of the amphiphilic compounds used to prepare the microblend.

### Example 7

### A Microblend of Bifenthrin with Nonionic Block Copolymer Melts

Microblends of Bifenthrin were prepared using melts of Pluronic block copolymers mixtures without using organic solvents. 124 mg of the first amphiphilic compound, Pluronic F127 and 124 mg of the second amphiphilic compound, Pluronic P123 were added to a round bottom flask, melted at 85° C. in water bath and thoroughly mixed upon rotation followed by evaporation of the traces of water in vacuo. 24.8 mg of fine powder of Bifenthrin, with the particle size below 425 mkm, were mixed with the copolymer and melted together in vacuo for 60 min. The feeding ratio of copolymer:Bifenthrin was 10:1. The melted composition was cooled down to a room temperature and then dispersed in 24.8 ml of water upon stirring. After 1 hour a slightly opalescent dispersion was formed. The total concentration of Pluronic copolymers in the dispersion was 1% wt. The size of the particles was 82 nm as determined by dynamic light scattering using “ZetaPlus” Zeta Potential Analyzer (Brookhaven Instrument Co.). The concentration of Bifenthrin in the dispersion was 1 mg/ml as determined by UV-spectroscopy as described in Example 1. The microblend loading capacity with respect to Bifenthrin was 10% w/w. No precipitation was observed in the prepared dispersion stored at a room temperature for 24 hours. Consequent measurements showed no change in the size of the particles in this dispersion. After 24 hours the formation of fine crystals of Bifenthrin was observed. The suspensions were centrifuged for 3 min at 13,000 rpm. The concentration of Bifenthrin in the supernatant was 0.58 mg/ml and the size of the particles was around 93 nm. The dispersion of the same microblend was stable at lower temperature, 8° C. In this case the dispersion was more turbid but no phase separation was observed for at least 96 hours. The size measurements performed at 15° C. revealed the particles of ca. 145 nm in diameter in the dispersion. The increase of temperature from 15° C. to 25° C. was accompanied with an increase in the size of the particles up to 230 nm. Despite the precipitation the residual dispersion contained 40% of the initially loaded Bifenthrin after 12 days of storage at room temperature and at 8° C. This demonstrates that the aqueous dispersions of microblends are stable at low temperature.

### Example 8

### A Microblend of Bifenthrin with Nonionic Block Copolymer Melts

This example describes microblends of three different amphiphilic compounds and a pesticide. 42.5 mg of Pluronic F127 were added to a round bottom flask and melted at 85° C. in a water bath upon rotation. 34 mg of Pluronic P123 in 0.5 ml of acetonitrile/methanol mixture (2:1 v/v) and 8.5 mg of Pluronic L121 in 0.085 ml of acetonitrile were added to the melt, thoroughly mixed upon rotation followed by rotor evaporation of the solvents and traces of water in vacuo. 8.5 mg of Bifenthrin in 85 ul of acetonitrile were mixed with the copolymer melt and solvent was evaporated in vacuo for 30 min. The feeding ratio of copolymer:Bifenthrin was 10:1. The melted composition was cooled down to room temperature and then was dispersed in 8.5 ml of water upon stirring. The total concentration of Pluronic copolymers in the dispersion was 1% wt. After 1 hour the opalescent dispersion was formed. No visible precipitation of Bifenthrin was observed for at least 24 hours. The concentration of Bifenthrin in the dispersion was 0.98 mg/ml as determined by UV-spectroscopy as described in Example 1. The microblend loading capacity with respect to Bifenthrin was 9.8% w/w. The size of the particles was 152 nm as determined by dynamic light scattering using “ZetaPlus” Zeta Potential Analyzer (Brookhaven Instrument Co.). An aliquot of microblend was centrifuged for 3 min at 13,000 rpm. The concentration of Bifenthrin in the supernatant was 0.7 mg/ml. Therefore, stable aqueous dispersions can be obtained using microblends of three different amphiphilic compounds and a pesticide.

### Example 9

### A Microblend of Bifenthrin with Nonionic Block Copolymer Melts

This example describes microblends of three different amphiphilic compounds and a pesticide. 63 mg of Pluronic F127, 50.4 mg of Pluronic P123, and 11.9 mg of Pluronic L101 were added to a round bottom flask and melted at 85° C. in water bath followed by evaporation of the traces of water in vacuo. The composition of the block copolymer mixture was Pluronic F127:Pluronic P123:Pluronic L101=5:4:1 by weight. 12.4 mg of fine powder of Bifenthrin, which contained particles of size of 425 um and less, were mixed with the copolymer and melted together in vacuo for 60 min. The feeding ratio of copolymer:Bifenthrin was 10:1. The melted composition was cooled down to room temperature and then dispersed in 12.5 ml of water upon stirring. The total concentration of Pluronic copolymers in the mixture was 1% wt. After 1 hour the opalescent dispersion was formed. No visible precipitation of Bifenthrin was observed for at least 24 hours. The concentration of Bifenthrin in the dispersion was 0.98 mg/ml as determined by UV-spectroscopy as described in Example 1. The microblend loading capacity with respect to Bifenthrin was 9.8% w/w. The size of the particles in the dispersion was 144 nm as determined by dynamic light scattering using “ZetaPlus” Zeta Potential Analyzer (Brookhaven Instrument Co.). After 40 hours the formation of fine crystals of Bifenthrin were observed. An aliquot of microblend was centrifuged for 3 min at 13,000 rpm. The concentration of Bifenthrin in the supernatant was 0.58 mg/ml. Despite the precipitation the residual dispersion contained 40% of loaded Bifenthrin after 12 days of storage at the room temperature.

### Example 10

### A Microblends of Bifenthrin with the Mixture of Block Copolymers Having Hydrophobic Blocks of Different Chemical Structure

In this example, microblends of a pesticide were prepared using melts of the binary mixture of block copolymers with hydrophobic blocks of different chemical structure, Pluronic F127 (PEO₁₀₀-PPO₆₅-PEO₁₀₀) and polystyrene-block-polyethylene oxide (PS₉₁-PEO₁₈₂ or PS-PEO). 42.5 mg of Pluronic F127 were mixed with 8.5 mg of PS-PEO in 85 ul of tetrahydrofuran in a round bottom flask. The resulted viscous solution was thoroughly mixed upon rotation at 85° C. in a water bath followed by removal of the solvent in vacuo. 5.1 mg of fine powder of Bifenthrin, with particle size below 425 mkm, were mixed with the copolymer mixture and melted together in vacuo for 30 min followed by rotor evaporation of the traces of water in vacuo. The composition of the copolymer mixture was Pluronic F127:PS-PEO=8.3:1.7 by weight. The feeding ratio of copolymers:Bifenthrin was 10:1. The melted composition was cooled down to room temperature and then dispersed in 5.1 ml of water upon stirring. The total concentration of the copolymers in the dispersion was 1% wt. After 1 hour an opalescent dispersion was formed. No visible precipitation of Bifenthrin was observed for 6 hours. The concentration of Bifenthrin in the dispersion was 0.95 mg/ml as determined by UV-spectroscopy as described in Example 1. The microblend loading capacity with respect to Bifenthrin was 9.5% w/w. The size of the particles was ca. 119 nm as determined by dynamic light scattering using “ZetaPlus” Zeta Potential Analyzer (Brookhaven Instrument Co.). An aliquot of microblend was centrifuged for 3 min at 13,000 rpm. The concentration of Bifenthrin in the supernatant was 0.91 mg/m and the size of the particles was 74 nm. After 6 h a formation white suspension containing fine crystals of Bifenthrin was formed. After incubation at room temperature for 48 hours the residual dispersion still contained particles of size of ca. 60 nm in diameter and 11% wt. of the initially loaded Bifenthrin. After two days of storage at room temperature the concentration of Bifenthrin in dispersion was 0.1 mg/m and the size of the particles was 60 mm. Therefore, stable aqueous dispersions can be obtained using microblends of a pesticide and amphiphilic compounds with hydrophobic moieties of different chemical structure.

### Example 11

### A Microblend of Bifenthrin with a Mixture of Nonionic Block Copolymers Having Hydrophobic Blocks of Different Chemical Structure

Microblends of Bifenthrin were prepared using melts of a tertiary mixture of block copolymers with hydrophobic blocks of different chemical structure, Pluronic F127 (PEO₁₀₀-PPO₆₅-PEO₁₀₀), Pluronic P123 (PEO₂₀-PPO₆₉-PEO₂₀), and PS-PEO (PS₉₁-PEO₁₈₂). 13.8 mg of Pluronic F127 and 13.8 mg of Pluronic P123 were mixed with 18.4 mg of PS-PEO in 184 ul of tetrahydrofuran in a round bottom flask. The resulting viscous solution was thoroughly mixed upon rotation at 85° C. in water bath followed by removal of the solvent in vacuo. 4.5 mg of fine powder of Bifenthrin, with a particle size below 425 mkm, were mixed with the copolymer mixture and melted together in vacuo for 30 min. The composition of the resulting copolymer mixture was Pluronic F127:Pluronic P123:PS-PEO=3:3:4 by weight. The feeding ratio of copolymers:Bifenthrin was 10:1. The melted composition was cooled down to room temperature and then dispersed in 4.6 ml of water upon stirring. The total concentration of Pluronic copolymers in the dispersion was 1% wt. After 12 hours opalescent dispersion with some tiny flakes was formed. No visible precipitation of Bifenthrin was observed. The concentration of Bifenthrin in the microblend was determined by UV-spectroscopy as described in Example A1 and was 0.93 mg/ml. The microblend loading capacity with respect to Bifenthrin was 9.5% w/w. The size of the copolymer particles loaded with Bifenthrin was 96 nm as determined by dynamic light scattering using “ZetaPlus” Zeta Potential Analyzer (Brookhaven Instrument Co.). An aliquot of microblend was centrifuged for 3 min at 13,000 rpm. The concentration of Bifenthrin in the supernatant was 0.9 mg/m and the size of the particles was 84 nm. The prepared microblend was stable for 40 hours at room temperature. After this period the formation of white flakes was observed. After 48 hours of storage at room temperature the suspension was centrifuged for 3 min at 13,000 rpm. The concentration of Bifenthrin in the microblend was 0.86 mg/ml. The size of the particles in the dispersion was around 91 mm. After incubation at the room temperature for 60 hours the residual dispersion contained 62% of the initially loaded Bifenthrin. After 5 days incubation at the room temperature the dispersion still contained 13% of the initially loaded Bifenthrin. Therefore, stable aqueous dispersions of an insoluble pesticide can be produced using microblends of tertiary mixtures of amphiphilic compounds with hydrophobic moieties of different chemical structure.

### Example 12

### A Microblend of Bifenthrin with a Mixture of Nonionic Block Copolymers and a Nonionic Amphiphilic Surfactant

In this example microblends of Bifenthrin were prepared using the melts of a mixture of polyethylene oxide-polypropylene oxide block copolymers and a nonionic amphiphilic surfactant, Zonyl FS300 (DuPont) containing a perfluorinated hydrophobic moiety and hydrophilic polyethylene oxide chain. This surfactant was used in combination with Pluronic copolymers, Pluronic F127 (PEO₁₀₀-PPO₆₅-PEO₁₀₀) and Pluronic P123 (PEO₂₀-PPO₆₉-PEO₂₀). 147 mg of Pluronic F127 and 147 mg of Pluronic P123 were mixed with 49 mg of Zonyl FS300 (122.5 ul of 40% aqueous solution) in a round bottom flask. The compounds were thoroughly mixed upon rotation at 85° C. in a water bath followed by removal of water in vacuo. 48 mg of fine powder of Bifenthrin, with the particle size below 425 mkm, were mixed with the copolymer/surfactant viscous blend and melted together in vacuo for 30 min followed by removal of the traces of water in vacuo. The composition of the copolymer/surfactant mixture Pluronic F127:Pluronic P123:Zonyl FS300 was 3:3:1 by weight. The feeding ratio of copolymer/surfactant:Bifenthrin was 7:1. The melted composition was cooled down to the room temperature. The final formulation was a yellow, wax-like solid. The 74.4 mg of solid formulation were dispersed in 7.44 ml of water upon stirring and an opalescent dispersion was formed after 1 hour. The total concentration of copolymer/surfactant components in the mixture was ca. 0.88%. No visible precipitation of Bifenthrin was observed. The concentration of Bifenthrin in the dispersion was 1.2 mg/ml as determined by UV-spectroscopy as described in Example 1. The microblend loading capacity with respect to Bifenthrin was 14% w/w. The size of the particles in the dispersion was 56 nm as determined by dynamic light scattering using “ZetaPlus” Zeta Potential Analyzer (Brookhaven Instrument Co.). The dispersion was stable for at least 6 hours. The formation of fine crystals of Bifenthrin was observed after 18 hours. At this time point the suspension was centrifuged for 3 min at 13,000 rpm. The concentration of Bifenthrin in the supernatant was 0.83 mg/ml. After incubation at the room temperature for 67 hours the residual dispersion still contained 32% of the initially loaded Bifenthrin.

### Example 13

### A Microblend of Bifenthrin with a Mixture of Nonionic Block Copolymers and a Nonionic Amphiphilic Surfactant

A microblend of Bifenthrin was prepared using the melts of the mixtures of nonionic block copolymers and an ethoxylated surfactant. Specifically, tristyrylphenol ethoxylate, Soprophor BSU (Rhodia) was used in combination with Pluronic copolymers, Pluronic F127 and Pluronic P123. 51.5 mg of Pluronic F127 and 50.2 mg of Pluronic P123 were mixed with 82 mg of Soprophor BSU in a glass vial at 85° C. 48 mg of fine powder of Bifenthrin, with the particle size below 425 mkm, were mixed with the copolymer/surfactant viscous blend and melted together for 30 min. The composition of the copolymer/surfactant mixture Pluronic F127:Pluronic P123:Soprophor BSU was 1:1:1.6 by weight. The feeding ratio of copolymer/surfactant:Bifenthrin was 10:1. The melted composition was cooled down to the room temperature. The final formulation was wax-like solid. 54 mg of the solid microblend formulation was dispersed in 5.4 ml of water upon stirring. This resulted in the formation of a transparent dispersion in 2 hours. The total concentration of the copolymer/surfactant components in the mixture was ca. 0.9% wt. The concentration of Bifenthrin in the microblend was 0.94 mg/ml as determined by UV-spectroscopy as described in Example 1. The microblend loading capacity with respect to Bifenthrin was 10.4% w/w. The size of the particles in the dispersion was 19 nm as determined by dynamic light scattering using “ZetaPlus” Zeta Potential Analyzer (Brookhaven Instrument Co.). The dispersion was stable for at least 30 hours without changes in the size of the particles or precipitation of Bifenthrin.

### Example 14

### A Microblend of Bifenthrin with Mixtures of Nonionic Block Copolymers and a Nonionic Amphiphilic Surfactant

A microblend of Bifenthrin was prepared using melts of the mixtures of nonionic block copolymers and an ethoxylated surfactants. Specifically, ethoxylated fatty alcohol (Agnique 90C-3, Cognis) was used in combination with Pluronic copolymers, Pluronic F127 and Pluronic P123. 72.7 mg of Pluronic F127 and 72.6 mg of Pluronic P123 were mixed with 95.7 mg of Agnique 90C-3 in a glass vial at 90° C. 26 mg of fine powder of Bifenthrin, with the particle of size below 425 mkm, were mixed with the copolymer/surfactant viscous blend and melted together for 30 min. The composition of the copolymer/surfactant mixture Pluronic F127:Pluronic P123:Agnique 90C-3 was 1:1:1.3 by weight. The feeding copolymer/surfactant:Bifenthrin ratio was 10:1.08. The melted composition was cooled down to room temperature. The final composition was a wax-like solid. 52 mg of the microblend composition was dispersed in 5.2 ml of water upon stirring. This resulted in the formation of an opalescent dispersion in 2 hours. The total concentration of the copolymer/surfactant components in the mixture was ca. 0.9% wt. An aliquot of microblend was centrifuged for 3 min at 13,000 rpm. The concentration of Bifenthrin in the supernatant was 0.54 mg/ml as determined by UV-spectroscopy as described in Example 1. The microblend loading capacity with respect to Bifenthrin was 5.4% w/w. The size of the microblend particles loaded with Bifenthrin was ca. 250 nm as determined by dynamic light scattering using “ZetaPlus” Zeta Potential Analyzer (Brookhaven Instrument Co.). After 24 hours of incubation of this dispersion at the room temperature a white precipitate was formed. Despite the observed precipitation the particle size in the residual dispersion was ca. 315 nm and the dispersion still contained 53% of the initially loaded Bifenthrin.

### Example 15

### A Microblend of Bifenthrin with a Single Nonionic Amphiphilic Surfactant

A microblend was prepared using (a) Zonyl FS300 as the first amphiphilic compound containing a hydrophobic perfluorinated moiety linked to a hydrophilic polyethylene oxide chain and (b) Bifenthrin as a second compound. 329 mg of Zonyl FS300 in 823 mg of 40% aqueous solution was heated at 100° C. 32.6 mg of the fine powder of Bifenthrin, with the particle size below 425 mkm, were mixed with the surfactant melt for 30 min. The feeding ratio of surfactant:Bifenthrin was 10:1. The melt composition was cooled down to a room temperature. The yellow wax-like solid was obtained. 70 mg of this solid composition was dispersed in 7 ml of water upon stirring. This led to the formation of an opalescent dispersion after 2 hours. An aliquot of this dispersion was centrifuged for 3 min at 13,000 rpm. The concentration of Bifenthrin in the microblend was 0.18 mg/ml as determined by UV-spectroscopy as described in Example 1. The microblend loading capacity with respect to Bifenthrin was 1.8% w/w. The size of the particles in the microblend dispersion was ca. 217 nm as determined by dynamic light scattering using “ZetaPlus” Zeta Potential Analyzer (Brookhaven Instrument Co.). The precipitation was observed after 24 hours. At this time point only 1% of initially loaded Bifenthrin was detected in the dispersions. By comparing this example with Example A12, one can conclude that the dispersions formed by microblends containing a single amphiphilic compound are less stable than those formed by microblends this amphiphilic compound and at least one more amphiphilic compounds.

### Example 16

### A Microblend of Bifenthrin with a Single Nonionic Block Copolymer

A microblend was prepared using (a) Pluronic F127 as the first amphiphilic compound and (b) Bifenthrin as a second compound. 71.6 mg of Pluronic F127 were mixed with 7.1 mg of fine powder of Bifenthrin, with the particle size below 425 mkm, and the components were melted together for 30 min at 90° C. The feeding ratio of copolymer:Bifenthrin was 10:1. The melted composition was cooled down to room temperature and then dispersed in 7.16 ml of water upon stirring. The total concentration of Pluronic F127 in the mixture was 1% wt. After 1 hour a slightly opalescent dispersion was formed. The concentration of Bifenthrin in the dispersion was 1 mg/ml as determined by UV-spectroscopy as described in Example 1. The microblend loading capacity with respect to Bifenthrin was 10% w/w. The size of the particles in the dispersion was 90.5 nm as determined by dynamic light scattering using “ZetaPlus” Zeta Potential Analyzer (Brookhaven Instrument Co.). No visible precipitation of Bifenthrin was observed for at least 8 hours. After 24 h formation of white suspensions containing fine crystals of Bifenthrin were observed. An aliquot of microblend was centrifuged for 3 min at 13,000 rpm. The concentration of Bifenthrin in the supernatant was only 0.07 mg/ml. By comparing this experiment with Experiment 3 one can conclude that the microblend prepared using a single hydrophilic-hydrophobic block copolymer forms less stable aqueous dispersions than the microblends containing the same block copolymer and at least one other amphiphilic compound.

### Example 17

### A Microblend of Bifenthrin with a Nonionic Block Copolymer Melts

A microblend was prepared using (a) a Tetronic T908 (M˜25,000, EO content: 81%, HLB>24) as the first hydrophilic compound and (b) Bifenthrin as a second compound. 36 mg of Tetronic T908 were mixed with 4 mg of fine powder of Bifenthrin, with particle size below 425 mkm, and melted together for 30 min at 90° C. The feeding ratio of copolymer:Bifenthrin was 9:1. The melted composition was cooled down to a room temperature and then dispersed in 4 ml of water. The total concentration of Tetronic T908 in the mixture was 0.9%. An opalescent dispersion was formed after 2 hours. The concentration of Bifenthrin in the dispersion was 1 mg/ml as determined by UV-spectroscopy as described in Example 1. The microblend loading capacity with respect to Bifenthrin was 10% w/w. The size of the particles in the dispersion was 119 nm as determined by dynamic light scattering using “ZetaPlus” Zeta Potential Analyzer (Brookhaven Instrument Co.). No visible precipitation of Bifenthrin was observed for at least 32 hours. After 24 h the particle size increased to 158 nm.

### Example 18

### A Microblend of Bifenthrin with Nonionic Block Copolymer Melts

A microblend was prepared using (a) a Tetronic T1107 (M˜15,000, EO content: 71%, HLB 18-23) as the first hydrophilic compound and (b) Bifenthrin as a second compound. 71 mg of Tetronic T1107 were mixed with 7.8 mg of fine powder of Bifenthrin, with the particle size of below 425 mkm, and melted together for 30 min at 90° C. The feeding ratio copolymer:Bifenthrin was 9:1. The melted composition was cooled down to room temperature. 22.1 mg of solid composition was dispersed in 2.21 ml of water upon stirring. This resulted in formation of an opalescent dispersion after 2 hours. The total concentration of Tetronic T1107 in the mixture was 0.9% wt. The concentration of Bifenthrin in the microblend was 0.98 mg/ml as determined by UV-spectroscopy as described in Example 1. The microblend loading capacity with respect to Bifenthrin was 11% w/w. The size of the particles formed in the dispersion was 89 nm as determined by dynamic light scattering using “ZetaPlus” Zeta Potential Analyzer (Brookhaven Instrument Co.). No visible precipitation of Bifenthrin was observed for at least 32 hours. After 24 h the particle size increased to 142 nm.

### Example 19

### A Microblend of Bifenthrin with Binary Mixtures of Nonionic Block Copolymers

Microblends of Bifenthrin were prepared using (a) Pluronic F127 (HLB 22, EO content: 70%) as a first amphiphilic compound and (b) Tetronic T 90R4 (M˜6,900, EO content: 49%, HLB 1-7), as a second compound. 84.1 mg of Pluronic F127, 81.2 mg of Tetronic 90R4 and 16.7 mg of fine powder of Bifenthrin, with the particle size below 425 mkm, were mixed and melted together for 30 min at 90° C. The melted composition was cooled down to a room temperature. The composition of the copolymer mixture was F127:Tetronic 90R4=1:1 by weight. The feeding ratio copolymers:Bifenthrin was 10:1. 46.5 mg of solid composition was dispersed in 4.65 ml of water. This resulted in formation of an opalescent dispersion after 2 hours. The total concentration of the copolymers in the mixture was 0.9% wt. The concentration of Bifenthrin in the microblend was 0.9 mg/ml as determined by UV-spectroscopy as described in Example 1. The size of the copolymer particles loaded with Bifenthrin was 88 nm as determined by dynamic light scattering using “ZetaPlus” Zeta Potential Analyzer (Brookhaven Instrument Co.). No visible precipitation of Bifenthrin was observed for at least 32 hours. After 24 h the particle size increased to 125 nm.

### Example 20

### Microblends of Bifenthrin with the Nonionic Block Copolymer and a Hydrophobic Homopolymer

Microblends of Bifenthrin were prepared using (a) Pluronic F127 (PEO₁₀₀-PPO₆₅-PEO₁₀₀) as the first amphiphilic compound and (b) a homopolymer polypropylene oxide (PPO36, M.W. 2,000) as the second compound. Briefly, the defined amounts of the components (Pluronic F127, PPO, and Bifenthrin) were mixed and melted together for 30 min at 80° C. The compositions of the prepared melts are presented in Table 6.

TABLE 6

| Composition | Dispersion A | Dispersion B |
|---|---|---|
| Composition of the mixture | 3:2:0.5 | 3:1:0.4 |
| Plutonic F127:PPO:Bifenthrin | | |
| Feeding ratio | 10:1 | 10:1 |
| Polymers:Bifenthrin | | |

The melted compositions were cooled down to room temperature and then dispersed in water. The total concentration of polymers in the dispersions was about 0.9% wt. The turbid dispersions were formed very slowly. No visible precipitation of Bifenthrin was observed. The sizes of the particles in these dispersions were 184 nm and 191 nm for the Dispersions A and B, respectively (as determined by dynamic light scattering using “ZetaPlus” Zeta Potential Analyzer (Brookhaven Instrument Co.)). No visible precipitation of Bifenthrin was observed for at least 24 hours. After this time the aliquots of microblends were centrifuged for 3 min at 13,000 rpm and the concentration of Bifenthrin was determined in the supernatants. These concentrations were 0.24 and 0.37 mg/ml for the Dispersions A and B, respectively, which corresponded to 25% and 43% of initially loaded Bifenthrin. By comparing this example with Example 16 one can conclude that by adding a hydrophobic polymer as a second compound in the microblend the stability of the pesticide aqueous dispersion formed by the microblend is increased.

### Example 21

### A Microblend of Bifenthrin with the Mixture of Nonionic Block Copolymers and Nonionic Ethoxylated Surfactant

Microblends of Bifenthrin were prepared using tristyrylphenol ethoxylate Soprophor BSU (Rhodia) combination with Pluronic F127 (PEO₁₀₀-PPO₆₅-PEO₁₀₀). 151.8 mg of Pluronic F127 were mixed with 37.8 mg of Soprophor BSU in glass vial at 90° C. 20 mg of fine powder of Bifenthrin, with the particle size below 425 mkm, were mixed with the copolymer/surfactant viscous blend and melted together for 30 min. The composition of the copolymer/surfactant mixture was Pluronic F127:Soprophor BSU=4:1:0.53 by weight. The feeding ratio of copolymer/surfactant:Bifenthrin was 9.5:1. The melt was cooled down to room temperature and a white solid material was obtained. 20.5 mg of this composition was dispersed in 3.9 ml of water upon stirring. This resulted in the formation of a practically transparent dispersion in about 40 minutes. The total concentration of the copolymer/surfactant components in the mixture was ca. 0.5%. The concentration of Bifenthrin in the microblend was 0.5 mg/ml as determined by UV-spectroscopy as described in Example 1. The microblend loading capacity with respect to Bifenthrin was 10.6% w/w. The size of the particles formed in the dispersion was 25.6 nm as determined by dynamic light scattering using “ZetaPlus” Zeta Potential Analyzer (Brookhaven Instrument Co.). The dispersion was stable for at least 18 hours revealing no changes in the particle size.

### Example 24

### Microblend of Bifenthrin with Binary Mixtures of Nonionic Block Copolymers with Nonionic Ethoxylated Surfactants

Microblends of bifenthrin were prepared using melts of binary mixtures of nonionic block copolymers and ethoxylated surfactants. Specifically, tristyrylphenol ethoxylate (Soprophor BSU, Rhodia) was used in combination with Pluronic F127 (PEO₁₀₀-PPO₆₅-PEO₁₀₀). 151.8 mg of Pluronic F127 were mixed with 37.8 mg of Soprophor BSU in glass vial at 90° C. 20 mg of fine powder of bifenthrin, which contained particles of size of 425 mkm and less, were mixed with the copolymer/surfactant viscous blend and melted together for 30 min. The composition of the copolymer/surfactant mixture was F127:Soprophor BSU=4:1:0.53 by weight. The feeding copolymer/surfactant:bifenthrin ratio was 9.5:1. The melted composition was cooled down to room temperature and white solid material was obtained. 20.5 mg of solid formulation was rehydrated in 3.9 ml of water upon stirring and practically transparent dispersion was formed in 40 minutes. The total concentration of copolymer/surfactant components in the mixture was ca. 0.5%. The content of bifenthrin in the microblend was determined by UV-spectroscopy as described in Example 1 and was ca. 0.5 mg/ml. The microblend loading capacity with respect to bifenthrin was 10.6 w/w %. The size of the microblend particles loaded with bifenthrin was 25.6 nm as determined by dynamic light scattering using “ZetaPlus” Zeta Potential Analyzer (Brookhaven Instrument Co.). The dispersion was stable at least for 18 hours without changes in size of the microblend.

### Example 25

### Microblend of Bifenthrin with Nonionic Block Copolymer Melt

Microblends of bifenthrin were prepared using melts of Tetronics block copolymers. Tetronics are tetrafunctional block copolymers derived from the sequential polymerization of propylene oxide and polyethylene oxide to ethylenediamine. Calculated amounts of Tetronic copolymer and fine powder of bifenthrin, which contained particles of size of 425 mkm and less, were mixed and melted together for 30 min at 85° C. The feeding copolymer:bifenthrin ratio was 9:1. The melted compositions were cooled down to room temperature and then were hydrated in water upon stirring. Characteristics of Tetronics T908 and T1107 used in these experiments and composition of the final mixtures were as shown in Table 7.

TABLE 7

| | Tetronic | Tetronic |
|---|---|---|
| Copolymer | T 908 | T 1107 |
| Molecular weight | 25,000 | 15,000 |
| HLB | >24 | 18-23 |
| Copolymer concentration in dispersion (wt %) | 0.9 | 0.9 |
| Content of bifenthrin (calculated, mg/ml) | 1 | 1 |

After 2 hour slightly opalescent dispersions were formed. The size of the copolymer particles loaded with bifenthrin were 119 nm for Tetronic T908/BF dispersion and 89 nm for Tetronic T1107 dispersion, respectively. No visible precipitation of bifenthrin was observed for at least 22 hours. The size measurements performed in 22 h revealed an increase in the size of the particles up to ca. 140-150 nm in both cases.

### Example 26

### Microblend of Bifenthrin with Nonionic Block Copolymer Melts

Microblends of bifenthrin were prepared using melts of Tetronic and Pluronic block copolymers. Specifically, binary mixture of tetrafunctional Tetronic 90R4 with poly(propylene oxide) blocks in the exterior of the macromolecule molecular weight 6,900, HLB 1-7) and Pluronic F127 (HLB 22) was used to prepare a final composition with bifenthrin. 84.1 mg of Pluronic F127 were mixed with 81.2 mg of Tetronic 90R4 in glass vial at 80° C. 16.7 mg of fine powder of bifenthrin, which contained particles of size of 425 mkm and less, were mixed with the copolymers viscous blend and melted together for 30 min. Composition of the copolymers/bifenthrin mixture was F127:Tetronic 90R4:BF=1:1:0.2 by weight. The feeding copolymers/bifenthrin ratio was 10:1. The melted composition was cooled down to room temperature and yellow wax-like material was obtained. 46.5 mg of final composition was rehydrated in 4.65 ml of water and opalescent dispersion was formed in 2 hours. The total concentration of copolymers components in the mixture was ca. 0.9%. The microblend loading capacity with respect to bifenthrin was 9.2 w/w %. The size of the microblend particles loaded with bifenthrin was 87.5 nm as determined by dynamic light scattering using “ZetaPlus” Zeta Potential Analyzer (Brookhaven Instrument Co.). The dispersion was stable at least for 22 hours. The size measurements performed in 22 h revealed an increase in the size of the particles up to 124 mm. No visible precipitation of bifenthrin was observed.

### Example 27

### Microblend of Bifenthrin with Binary Mixtures of Nonionic Block Copolymers with Nonionic Ethoxylated Surfactants

Microblends of bifenthrin were prepared using melts of binary mixtures of nonionic block copolymers and ethoxylated surfactants. Specifically, tristyrylphenol ethoxylate (Soprophor BSU, Rhodia) was used in combination with Tetronic T 908, tetrafunctional copolymer of poly(propylene oxide) and poly(ethylene oxide). 210 mg of Tetronic T908 were mixed with 70.2 mg of Soprophor BSU in glass vial at 80° C. 58.8 mg of fine powder of bifenthrin, which contained particles of size of 425 mkm and less, were mixed with the copolymer/surfactant viscous blend and melted together for 30 min. Composition of the copolymer/surfactant/bifenthrin mixture was T 908:Soprophor BSU=3:1:0.85 by weight. The feeding copolymer/surfactant:bifenthrin ratio was 5.8:1. The melted composition was cooled down to room temperature and white solid material was obtained. 41.7 mg of solid formulation was rehydrated in 4.17 ml of water overnight and stable opaque dispersion was formed. The total concentration of copolymer/surfactant components in the mixture was ca. 0.8%. The microblend loading capacity with respect to bifenthrin was 17.3 w/w %. The size of the microblend particles loaded with bifenthrin was 87.4 nm as determined by dynamic light scattering using “ZetaPlus” Zeta Potential Analyzer (Brookhaven Instrument Co.). The dispersion was stable at least for 16 hours without changes in size of the microblend. The formation of tiny crystals of bifenthrin was observed in 20 hour upon storage of the dispersion at room temperature.

### Example 28

### Microblend of Bifenthrin with Mixtures of Nonionic Block Copolymers with Nonionic Ethoxylated Surfactants

Microblends of bifenthrin were prepared using melts of mixtures of nonionic block copolymers and ethoxylated surfactants. Specifically, ethoxylated fatty alcohol (Agnique 90C-3, Cognis) was used in combination with Pluronic copolymers, Pluronic F127 (PEO₁₀₀-PPO₆₅-PEO₁₀₀) and Pluronic P123 (PEO₂₀-PPO₆₉-PEO₂₀). 40.4 mg of Pluronic F127 and 40.3 mg of Pluronic P123 were mixed with 21.9 mg of Agnique 90C-3 in glass vial. 18.6 mg of fine powder of bifenthrin, which contained particles of size of 425 mkm and less, were mixed with the copolymer/surfactant viscous blend and melted together for 30 min at 80° C. The composition of the copolymer/surfactant mixture was F127:P123:Agnique 90C-3=2:2:1 by weight. The feeding copolymer/surfactant:bifenthrin ratio was 10:1.8. The melted composition was cooled down to room temperature. The final formulation was a wax-like solid. 12.3 mg of solid formulation were mixed with 80 μl of methanol until complete dissolution followed by addition of 2.46 ml of water. A slightly opalescent dispersion was formed immediately. The total concentration of copolymer/surfactant components in the mixture was ca. 0.4%. and content of methanol was 3 v/v %. The content of bifenthrin in the microblend was 0.74 mg/ml. The microblend loading capacity with respect to bifenthrin was 15.3 w/w %. The size of the copolymer particles loaded with bifenthrin was 96 nm as determined by dynamic light scattering using “ZetaPlus” Zeta Potential Analyzer (Brookhaven Instrument Co.). The microblend was stable for 32 hours.

### Example 29

### Microblend of Bifenthrin with Mixtures of Nonionic Block Copolymers with Nonionic Ethoxylated Surfactants

Microblends of bifenthrin were prepared using mixtures of nonionic block copolymers and ethoxylated surfactants. Specifically, ethoxylated cocoalkyl amine (Ethoquad C/25, AkzoNobel) was used in combination with Tetronic T 908, tetrafunctional copolymer of poly(propylene oxide) and poly(ethylene oxide) (molecular weight 25,000, HLB>24). All components of the blend were used as 10% stock solutions in acetonitrile. Solutions containing 7.6 mg of Tetronic copolymer, 0.4 mg of Ethoquad C/25, and 2 mg of bifenthrin were added to a round bottom flask, thoroughly mixed upon rotation at 45° C. in a water bath followed by rotor evaporation of solvents and traces of water in vacuo. The composition of the copolymer/surfactant mixture was Tetronic T908:Ethoquad C/25=19:1 by weight. The feeding copolymer/surfactant:bifenthrin ratio was 4:1. The obtained solid film was rehydrated in 4 ml of water (targeted content of bifenthrin is 0.5 mg/ml) and a slightly opalescent dispersion was formed immediately. The total concentration of copolymer/surfactant components in the mixture was ca. 0.2%. The content of bifenthrin in the microblend was determined by UV-spectroscopy as described in Example 1 and was 0.49 mg/ml. The microblend loading capacity with respect to bifenthrin was 20 w/w %. The size of the microblend particles loaded with bifenthrin was 107 nm as determined by dynamic light scattering using “ZetaPlus” Zeta Potential Analyzer (Brookhaven Instrument Co.). The dispersion was stable at least for 23 hours. The size measurements performed in 23 h revealed an increase in the size of the particles up to 167 nm. No visible precipitation of bifenthrin was observed. After storage for 42 hours at room temperature, an aliquot of the microblend was centrifuged for 2 min at 12,000 rpm. The content of bifenthrin in the supernatant was 0.13 mg/ml or 26% of initially loaded bifenthrin.

### Example 30

### Microblend of Bifenthrin with Nonionic Block Copolymer

A microblend of bifenthrin was prepared using Pluronic P85 (n=26, m=40) block copolymer of intermediate hydrophilic-lipophilic balance (HLB 12-18). 8 mg of Pluronic P85 were mixed with 2 mg of fine powder of bifenthrin, which contained particles of size of 425 mkm and less, dissolved in 1 ml of acetonitrile, and thoroughly mixed upon rotation at 45° C. in water bath followed by rotor evaporation of solvent and traces of water in vacuo. The feeding copolymer:bifenthrin ratio was 4:1. The prepared composition was rehydrated in 2 ml of water (targeted content of bifenthrin was 1 mg/ml) and practically transparent dispersion was formed immediately. The total concentration of Pluronic P85 in the mixture was 0.4%. The content of bifenthrin in the microblend was determined by UV-spectroscopy as described in Example 1 and was 1 mg/ml. The microblend loading capacity with respect to bifenthrin was 20 w/w %. The size of the copolymer particles loaded with bifenthrin was 35 nm as determined by dynamic light scattering using “ZetaPlus” Zeta Potential Analyzer (Brookhaven Instrument Co.). No visible precipitation of bifenthrin was observed for at least 18 hours. A similar dispersion prepared at a targeted content of bifenthrin of 0.5 mg/ml was stable for at least 26 hours. The size measurements performed during the storage of the dispersions at room temperature revealed an increase in the size of the particles as shown in Table 8.

TABLE 8

Content of bifenthrin in dispersion

| | |
|---|---|
| 1 mg/ml | 0.5 mg/ml |

| | |
|---|---|
| Time (hours) | Particle size, nm |

| | | |
|---|---|---|
| 0 | 35 | 34 |
| 2 | 53 | 54 |
| 7 | 64 | 70 |
| 18 | 82 | 75 |
| 26 | precipitation | 85 |

### Example A31

### Microblend of Bifenthrin with Mixtures of Nonionic Block Copolymers with Nonionic Ethoxylated Surfactants

Microblends of bifenthrin were prepared using mixtures of nonionic block copolymers and ethoxylated surfactants. Specifically, ethoxylated cocoalkyl amine (Ethoquad C/25, AkzoNobel) was used in combination with Tetronic T 1107, tetrafunctional copolymer of poly(propylene oxide) and poly(ethylene oxide) (molecular weight 15,000, HLB 18-23). All components of the blend were used as 10% stock solutions in acetonitrile. Solutions containing 7.6 mg of Tetronic copolymer, 0.4 mg of Ethoquad C/25, and 2 mg of bifenthrin were added to round bottom flask, thoroughly mixed upon rotation at 45° C. in water bath followed by rotor evaporation of solvents and traces of water in vacuo. Composition of the copolymer/surfactant mixture was T908:Ethoquad C/25=19:1 by weight. The feeding copolymer/surfactant:bifenthrin ratio was 4:1. The obtained solid film was rehydrated in 4 ml of water (targeted content of bifenthrin is 0.5 mg/ml) and slightly opalescent dispersion was formed immediately. The total concentration of copolymer/surfactant components in the mixture was ca. 0.2%. The content of bifenthrin in the microblend was determined by UV-spectroscopy as described in Example 1 and was 0.48 mg/ml. The microblend loading capacity with respect to bifenthrin was 20 w/w %. The size of the microblend particles loaded with bifenthrin was 43 nm as determined by dynamic light scattering using “ZetaPlus” Zeta Potential Analyzer (Brookhaven Instrument Co.). The dispersion was stable at least for 30 hours. The size measurements performed in 30 h revealed an increase in the size of the particles up to 120 nm. No visible precipitation of bifenthrin was observed. After storage for 42 hours at room temperature, an aliquot of microblend was centrifuged for 2 min at 12,000 rpm. The content of bifenthrin in the supernatant was 0.2 mg/ml or 40% of initially loaded bifenthrin.

### Example 32

### Microblend of Bifenthrin with Mixtures of Nonionic Block Copolymers with Nonionic Ethoxylated Surfactants

Microblends of bifenthrin were prepared using mixtures of nonionic block copolymers and ethoxylated surfactants. Specifically, ethoxylated cocoalkyl amine (Ethoquad C/25, AkzoNobel) was used in combination with Tetronic T 1107, tetrafunctional copolymer of poly(propylene oxide) and poly(ethylene oxide) (molecular weight 15,000, HLB 18-23). All components of the blend were used as 10% stock solutions in acetonitrile. Solutions containing 7.6 mg of Tetronic copolymer, 0.4 mg of Ethoquad C/25, and 2 mg of bifenthrin were added to round bottom flask, thoroughly mixed upon rotation at 45° C. in water bath followed by rotor evaporation of solvents and traces of water in vacuo. Composition of the copolymer/surfactant mixture was T1107:Ethoquad C/25=19:1 by weight. The feeding copolymer/surfactant:bifenthrin ratio was 4:1. The obtained solid film was rehydrated in 4 ml of water (targeted content of bifenthrin is 0.5 mg/ml) and slightly opalescent dispersion was formed immediately. The total concentration of copolymer/surfactant components in the mixture was ca. 0.2%. The content of bifenthrin in the microblend was determined by UV-spectroscopy as described in Example 1 and was 0.48 mg/ml. The microblend loading capacity with respect to bifenthrin was 20 w/w %. The size of the microblend particles loaded with bifenthrin was 43 nm as determined by dynamic light scattering using “ZetaPlus” Zeta Potential Analyzer (Brookhaven Instrument Co.). The dispersion was stable at least for 30 hours. The size measurements performed in 30 h revealed an increase in the size of the particles up to 120 nm. No visible precipitation of bifenthrin was observed. After storage for 42 hours at room temperature, an aliquot of microblend was centrifuged for 2 min at 12,000 rpm. The content of bifenthrin in the supernatant was 0.2 mg/ml or 40% of initially loaded bifenthrin.

### Example 33

### Microblend of Bifenthrin with Nonionic Block Copolymer

Microblend of bifenthrin was prepared using Pluronic P85 (n=26, m=40) block copolymer of intermediate hydrophilic-lipophilic balance (HLB 12-18). 8 mg of Pluronic P85 were mixed with 2 mg of fine powder of bifenthrin, which contained particles of size of 425 mkm and less, dissolved in 1 ml of acetonitrile, and thoroughly mixed upon rotation at 45° C. in water bath followed by rotor evaporation of solvent and traces of water in vacuo. The feeding copolymer:bifenthrin ratio was 4:1. The prepared composition was rehydrated in 2 ml of water (targeted content of bifenthrin was 1 mg/ml) and practically transparent dispersion was formed immediately. The total concentration of Pluronic P85 in the mixture was 0.4%. The content of bifenthrin in the microblend was determined by UV-spectroscopy as described in Example 1 and was 1 mg/ml. The microblend loading capacity with respect to bifenthrin was 20 w/w %. The size of the copolymer particles loaded with bifenthrin was 35 nm as determined by dynamic light scattering using “ZetaPlus” Zeta Potential Analyzer (Brookhaven Instrument Co.). No visible precipitation of bifenthrin was observed for at least 18 hours. The similar dispersion prepared at targeted content of bifenthrin of 0.5 mg/ml was stable for at least 26 hours. The size measurements performed during the storage of the dispersions at room temperature revealed an increase in the size of the particles as shown in Table 9.

TABLE 9

Content of bifenthrin in dispersion

| | |
|---|---|
| 1 mg/ml | 0.5 mg/ml |

| | |
|---|---|
| Time (hours) | Particle size, nm |

| | | |
|---|---|---|
| 0 | 35 | 34 |
| 2 | 53 | 54 |
| 7 | 64 | 70 |
| 18 | 82 | 75 |
| 26 | precipitation | 85 |

### Example 34

### Microblend of Bifenthrin with Nonionic Block Copolymers

Microblends of bifenthrin were prepared using Pluronic R block copolymers. Pluronic R copolymers consist of ethylene oxide (EO) and propylene oxide (PO) blocks arranged in the following structure: POₙ-EOₘ-POₙ, which is the inverse of the Pluronic structure, as shown in formula (III). Calculated amounts of Pluronic 25R4 (PO₁₉-EO₃₃-PO₁₉, molecular weight 3600, HLB 8) copolymer and fine powder of bifenthrin, which contained particles of size of 425 mkm and less, were respectively dissolved in acetonitrile to prepare 10% solutions of each component. Solutions containing 8 mg of 25R4 copolymer and 2 mg of bifenthrin were added to round bottom flask, thoroughly mixed upon rotation at 45° C. in water bath followed by rotor evaporation of solvents and traces of water in vacuo. The feeding copolymer:bifenthrin ratio was 4:1. The prepared composition was rehydrated in 2 ml of water (targeted content of bifenthrin was 1 mg/ml) and practically transparent dispersion was formed immediately. The total concentration of copolymer components in the mixture was ca. 0.4%. The content of bifenthrin in the microblend was determined by UV-spectroscopy as described in Example 1 and was ca. 1 mg/ml. The microblend loading capacity with respect to bifenthrin was 20 w/w %. The size of the microblend particles loaded with bifenthrin was 106 nm as determined by dynamic light scattering using “ZetaPlus” Zeta Potential Analyzer (Brookhaven Instrument Co.). The dispersion was stable at least for 24 hours without changes in size of the microblend.

### Example 35

### Microblend of Bifenthrin with Mixtures of Nonionic Block Copolymers with Nonionic Ethoxylated Surfactants

Microblends of bifenthrin were prepared using mixtures of nonionic Pluronic R block copolymers and ethoxylated surfactants. Specifically, tristyrylphenol ethoxylate (Soprophor BSU, Rhodia) was used in combination with Pluronic 25R4 (PO₁₉-EO₃₃-PO₁₉, molecular weight 3600, HLB 8) a copolymer of a general structure formula (III). Calculated amounts of Pluronic 25R4 copolymer, Soprophor BSU, and fine powder of bifenthrin, which contained particles of size of 425 mkm and less, were respectively dissolved in acetonitrile to prepare 10% solutions of each component. Solutions containing 7 mg of Pluronic 25R4 copolymer, 1 mg of Soprophor BSU surfactant, and 2 mg of bifenthrin were added to round bottom flask, thoroughly mixed upon rotation at 45° C. in water bath followed by rotor evaporation of solvents and traces of water in vacuo. Composition of the copolymer/surfactant mixture was Pluronic 25R4:Soprophor BSU=7:1 by weight. The feeding copolymer/surfactant:bifenthrin ratio was 4:1. The prepared composition was rehydrated in 2 ml of water (targeted content of bifenthrin was 1 mg/ml) and transparent dispersion was formed immediately. The total concentration of copolymer/surfactant components in the mixture was ca. 0.4%. The content of bifenthrin in the microblend was determined by UV-spectroscopy as described in Example 1 and was ca. 1 mg/ml. The microblend loading capacity with respect to bifenthrin was 20 w/w %. The size of the microblend particles loaded with bifenthrin was 33 nm as determined by dynamic light scattering using “ZetaPlus” Zeta Potential Analyzer (Brookhaven Instrument Co.). The size measurements performed in 13 hours revealed an increase in the size of the particles up to 52 nm. Precipitation of bifenthrin was observed after storage of the dispersion for 24 hours at room temperature.

### Example 36

### Microblend of Fungicide with Mixtures of Nonionic Block Copolymers with Nonionic Ethoxylated Surfactants

Microblends of Flutriafol, triazole fungicide, were prepared using mixtures of nonionic Pluronic block copolymers and ethoxylated surfactants. Specifically, tristyrylphenol ethoxylate (Soprophor BSU, Rhodia) was used in combination with Pluronic P123 (PEO₂₀-PPO₆₉-PEO₂₀, molecular weight 5,750, HLB 8) copolymer. Calculated amounts of Pluronic P123 copolymer and Soprophor BSU were respectively dissolved in acetonitrile to prepare 10% solutions of each component. Flutriafol was dissolved in acetonitrile to prepare 4% solution. Solutions containing 7 mg of Pluronic P123 copolymer, 1 mg of Soprophor BSU surfactant, and 2 mg of flutriafol were thoroughly mixed together followed by evaporation of solvents. The composition of the copolymer/surfactant mixture was Pluronic P123:Soprophor BSU=7:1 by weight. The feeding copolymer/surfactant:flutriafol ratio was 4:1. The prepared composition was rehydrated in 2 ml of water (targeted content of flutriafol was 1 mg/ml) and transparent dispersion was formed immediately. The total concentration of copolymer/surfactant components in the mixture was ca. 0.4%. The microblend loading capacity with respect to flutriafol was 20 w/w %. The size of the microblend particles loaded with flutriafol was 18 nm as determined by dynamic light scattering using “ZetaPlus” Zeta Potential Analyzer (Brookhaven Instrument Co.). Precipitation of flutriafol was observed after storage of the dispersion for 8 hours at room temperature.

### Example 37

### Microblend of Fungicide with Binary Mixtures of Nonionic Block Copolymers with Anionic Ethoxylated Surfactants

Microblends of Flutriafol, triazole fungicide, were prepared using binary mixtures of nonionic block copolymers and anionic ethoxylated surfactants. Specifically, phosphated and ethoxylated tristyrylphenol with an HLB equal to 16 (Soprophor 3D33, Rhodia) was used in combination with Tetronic T 1107, tetrafunctional copolymer of poly(propylene oxide) and poly(ethylene oxide) (molecular weight 15,000, HLB 24). Calculated amounts of Tetronic copolymer T1107 and flutriafol were dissolved in acetonitrile to prepare 10% and 4% solutions, respectively. 17% solution of Soprophor 3D33 was prepared in ethanol. Microblends were prepared as described in Example 36. Compositions of the final mixtures were as shown in Table 10.

TABLE 10

| Composition | 37A | 37B |
|---|---|---|
| Composition of Tetronic T1107:Soprophor 3D33 | 7:1 | 7:1 |
| mixture (by weight) | | |
| Feeding copolymer/surfactant:flutriafol ratio | 4:1 | 5.3:1 |
| Targeted loading (%) | 20.0 | 15.8 |

The prepared compositions were rehydrated in 2 ml of water and transparent dispersions were formed immediately. The size of the microblend particles loaded with flutriafol (as determined by dynamic light scattering using “ZetaPlus” Zeta Potential Analyzer (Brookhaven Instrument Co.)), targeted content of flutriafol and stability of the dispersions are presented in Table 11.

TABLE 11

| Composition | 37A | 37B |
|---|---|---|
| Concentration of copolymer/surfactant components (wt %) | 0.4 | 0.4 |
| Targeted content of flutriafol (mg/ml) | 1.0 | 0.75 |
| Particle size (nm) | 43 | 37 |
| Dispersion stability (hours) | 4 | 7 |

### Example 38

### Microblend of Fungicide with Binary Mixtures of Nonionic Block Copolymers with Anionic Ethoxylated Surfactants

Microblends of Azoxystrobin, systemic stobilurin fungicide, were prepared using binary mixtures of nonionic block copolymers and anionic ethoxylated surfactants. Specifically, phosphated and ethoxylated tristyrylphenol with an HLB equal to 16 (Soprophor 3D33, Rhodia) was used in combination with Tetronic T 1107, tetrafunctional copolymer of poly(propylene oxide) and poly(ethylene oxide) (molecular weight 15,000, HLB 24). A calculated amount of Tetronic T1107 copolymer was dissolved in acetonitrile to prepare 10% solution. Azoxystrobin was dissolved in acetonitrile to prepare 4% solution. 17% solution of Soprophor 3D33 was prepared in ethanol. Solutions containing 6 mg of Tetronic T1107 copolymer, 2 mg of Soprophor 3D33 surfactant, and 2 mg of azoxystrobin were thoroughly mixed together followed by evaporation of solvents. The composition of the copolymer/surfactant mixture was Tetronic T1107:Soprophor 3D33=3:1 by weight. The feeding copolymer/surfactant:azoxystrobin ratio was 4:1. The prepared composition was rehydrated in 2 ml of water (targeted content of azoxystrobin was 1 mg/ml) and opalescent dispersion was formed. The total concentration of copolymer/surfactant components in the mixture was ca. 0.4%. The microblend loading capacity with respect to azoxystrobin was 20 w/w %. The size of the microblend particles loaded with azoxystrobin was 130 nm as determined by dynamic light scattering using “ZetaPlus” Zeta Potential Analyzer (Brookhaven Instrument Co.). The dispersion became more turbid upon storage at room temperature. No visible precipitation was observed in the dispersion for at least 4 hours.

### Example A39

### Microblend of Fungicide with Binary Mixtures of Nonionic Block Copolymers with Anionic Ethoxylated Surfactants

Microblends of Azoxystrobin, systemic stobilurin fungicide, were prepared using binary mixtures of Tetronic T704 (molecular weight 5,500, HLB 15) and anionic phosphated and ethoxylated tristyrylphenol surfactant, Soprophor 3D33. Microblends were prepared as described in Example 38. Solutions in organic solvents containing Tetronic T704 copolymer, Soprophor 3D33 surfactant, and azoxystrobin were thoroughly mixed together followed by evaporation of solvents. Compositions of the final mixtures were as shown in Table 12.

TABLE 12

| Composition | 39A | 39B |
|---|---|---|
| Composition of Tetronic T704 | 3.5:1 | 4:1 |
| mixture (by weight):Soprophor 3D33 | | |
| Feeding copolymer/surfactant:azoxystrobin ratio | 9:1 | 8:1 |
| Targeted loading (%) | 10.0 | 11.0 |

The prepared compositions were rehydrated in 2 ml of water. The size of the microblend particles loaded with flutriafol (as determined by dynamic light scattering using “ZetaPlus” Zeta Potential Analyzer (Brookhaven Instrument Co.)), targeted content of flutriafol and stability of the dispersions are presented in Table 13.

TABLE 13

| Composition | 39A | 39B |
|---|---|---|
| Concentration of copolymer/surfactant | 0.45 | 0.4 |
| components (wt %) | | |
| Targeted content of azoxystrobin (mg/ml) | 0.5 | 0.75 |
| Dispersion appearance | transparent | turbid |
| Particle size (nm) | 11 | 148 |
| Dispersion stability (hours) | 4 | 5 |

### Example 40

### Microblend of Fungicide with Mixtures of Nonionic Block Copolymers with Nonionic Fluorine Containing Surfactants

Microblend of flutriafol was prepared using mixtures of nonionic block copolymers and surfactants containing fluorine. Specifically, Zonyl FS300 surfactant (DuPont) containing perfluorinated hydrophobic tail and hydrophilic poly(ethylene oxide) head group, was used in combination with Tetronic T1107 copolymer (molecular weight 15,000, HLB 24). Microblend was prepared as described in Example 36. Briefly, solutions in organic solvents containing 6 mg of Tetronic T1107 copolymer, 2 mg of Zonyl FS300 surfactant, and 2 mg of flutriafol were thoroughly mixed together followed by evaporation of solvents. Composition of the copolymer/surfactant mixture was Tetronic T1107:Zonyl FS300=3:1 by weight. The feeding copolymer/surfactant:flutriafol ratio was 4:1. The prepared composition was rehydrated in 2 ml of water (targeted content of flutriafol was 1 mg/ml) and practically transparent dispersion was formed. The total concentration of copolymer/surfactant components in the mixture was ca. 0.4%. The microblend loading capacity with respect to flutriafol was 20 w/w %. The size of the microblend particles loaded with flutriafol was 111 nm as determined by dynamic light scattering using “ZetaPlus” Zeta Potential Analyzer (Brookhaven Instrument Co.). No visible precipitation was observed in the dispersion for at least 4 hours.

### Example 41

### Microblend of Fungicide with Mixtures of Nonionic Block Copolymers with Nonionic Fluorine Containing Surfactants

Microblend of azoxystrobin was prepared using mixtures of nonionic block copolymers and surfactants containing fluorine. Specifically, Zonyl FS300 surfactant (DuPont) containing perfluorinated hydrophobic tail and hydrophilic poly(ethylene oxide) head group, was used in combination with Tetronic T704 copolymer (molecular weight 5,500, HLB 15). Microblend was prepared as described in Example 38. Briefly, solutions in organic solvents containing 7 mg of Tetronic T704 copolymer, 2 mg of Zonyl FS300 surfactant, and 1 mg of azoxystrobin were thoroughly mixed together followed by evaporation of solvents. Composition of the copolymer/surfactant mixture was Tetronic T704:Zonyl FS300=3.5:1 by weight. The feeding copolymer/surfactant:azoxystrobin ratio was 9:1. The prepared composition was rehydrated in 2 ml of water (targeted content of azoxystrobin was 0.5 mg/ml) and turbid dispersion was formed. The total concentration of copolymer/surfactant components in the mixture was ca. 0.45%. The microblend loading capacity with respect to flutriafol was 10 w/w %. The size of the microblend particles loaded with azoxystrobin was ca. 200 nm as determined by dynamic light scattering using “ZetaPlus” Zeta Potential Analyzer (Brookhaven Instrument Co.). No visible precipitation was observed in the dispersion for at least 8 hours.

### Example 42

### Microblends of Various Insecticides with the Mixtures of a Nonionic Block Copolymer and a Nonionic Ethoxylated Surfactant

Compositions of insecticides were prepared using melts of mixtures of nonionic block copolymer and ethoxylated surfactants. Specifically, tristyrylphenol etoxylate (Soprophor BSU, Rhodia) was used in combination with Pluronic P123 (PEO₂₀-PPO₆₉-PEO₂₀). 250 mg of Pluronic P123 were mixed with 250 mg of Soprophor BSU, and 50 mg of fine powder of the insecticide, and were melted together for 1 hour. The composition of the copolymer/surfactant mixture was P123:Soprophor=1:1 by weight. The feeding copolymer/surfactant:insecticide ratio was 10:1. The melted compositions were cooled down to room temperature. The final compositions were wax-like solids. 50 mg of the composition was rehydrated in 1 ml of water upon shaking for 1 hour. The total concentration of copolymer/surfactant components in the mixture was ca. 4.6%. The targeted content of insecticide in the microblend dispersion was 4.5 mg/ml. The microblend loading capacity with respect to insecticide was 9 w/w %. The size of the particles in the microblend dispersions loaded with insecticides (as determined by dynamic light scattering using “Nanotrac 250” Size Analyzer (Microtrac Inc.) after 2 hours), and dispersion appearance after 24 hours of the storage at room temperature are presented in Table 14.

TABLE 14

| | Particle size | Dispersion appearance |
|---|---|---|
| Insecticide | (nm) | in 24 hours |
| Cypermethrin | 14 | clear |
| Bifenthrin | 14 | clear |
| Profenofos | 13 | clear |
| Abamectin | 13 | clear |
| Fipronil | 13 | clear |
| Spinosad | 13 | clear |
| Pyridalyl | 14 | clear |

### Example 43

### Microblends of Bifenthrin with Mixtures of a Nonionic Block Copolymer and an Anionic Ethoxylated Surfactant

Compositions of bifenthrin were prepared using melts of mixtures of nonionic block copolymer and ethoxylated surfactants. Specifically, sulfated and ethoxylated tristyrylphenol (Soprophor 4D-384, Rhodia) was used in combination with Pluronic P123 (PEO₂₀-PPO₆₉-PEO₂₀). The compositions were prepared as described in Example A22. Briefly, the defined amounts of the components (Pluronic P123, Soprophor 4D384, and Bifenthrin) were mixed and melted together for 30 min. Compositions of the copolymer/surfactant mixtures are presented in Table 15. The feeding copolymer/surfactant:bifenthrin ratio was 20:1. The melted compositions were cooled down to room temperature. The final compositions were viscous liquids. 50 mg of the composition was rehydrated in 1 ml of water and transparent dispersion was formed immediately. The targeted content of Bifenthrin in the microblend dispersion was 4.5 mg/ml. The size of the particles in the microblend dispersions loaded with Bifenthrin (as determined by dynamic light scattering using “Nanotrac 250” Size Analyzer (Microtrac Inc.)), and dispersion appearance after 48 hours of the storage at room temperature are presented in Table 15.

TABLE 15

| Composition of the Pluronic P123: | | |
|---|---|---|
| Soprophor 4D-384 mixture (by | Particle size | Dispersion appearance |
| weight) | (nm) | in 48 hours |
| 4:6 | 16 | clear |
| 7:3 | 13 | clear |

### Example 44

### Microblends of Bifenthrin with the Mixtures of a Nonionic Block Copolymers and Nonionic Surfactant

Compositions of Bifenthrin were prepared using melts of mixtures of nonionic block copolymers and nonionic surfactant. Specifically, Sorbitan trioleate (Cognis) was used in combination with Pluronic copolymers, Pluronic F127 (PEO₁₀₀-PPO₆₅-PEO₁₀₀) and Pluronic P123 (PEO₂₀-PPO₆₉-PEO₂₀). The composition was prepared as described in Example A22. Briefly, the defined amounts of the components (Pluronic P123, Pluronic F127, Sorbitan trioleate, and Bifenthrin) were mixed and melted together for 30 min. Composition of the copolymer/surfactant mixture was F127:P123:surfactant=3:6:1 by weight. The feeding copolymer/surfactant:Bifenthrin ratio was 20:1. The melted compositions were cooled down to room temperature. 50 mg of the composition was rehydrated in 1 ml of water and opalescent dispersion was formed upon stirring. The targeted content of Bifenthrin in the microblend dispersion was 4.5 mg/ml. The size of the particles in the microblend dispersion loaded with Bifenthrin was 23 nm as determined by dynamic light scattering using “Nanotrac 250” Size Analyzer (Microtrac Inc.). The dispersion remained stable for at least 48 hours of the storage at room temperature.

### Example 45

### Microblends of Bifenthrin with the Mixtures of a Nonionic Block Copolymers and Anionic Ethoxylated Surfactant

Compositions of Bifenthrin were prepared using melts of mixtures of nonionic block copolymers and nonionic surfactant. Specifically, ethoxylated polyarylphenol phosphate ester (Soprophor 3D33, Rhodia) was used in combination with Pluronic P123 (PEO₂₀-PPO₆₉-PEO₂₀). 500 mg of Pluronic P123 were mixed with 500 mg of Soprophor 3D33 and 100 mg of fine powder of the bifenthrin, which contained particles of size of 425 mkm and less, and then were melted together at 70° C. A clear liquid melt was obtained, containing 9% bifenthrin. The composition was allowed to cool to room temperature and 100 mg of the melt was added to 10 mL of deionized water and shaken. After 10 minutes shaking, a clear dispersion had formed. The targeted content of bifenthrin in the microblend dispersion was 0.9 mg/ml. The size of the particles in the microblend dispersion loaded with bifenthrin after 30 min was 5.3 nm as determined by dynamic light scattering using “Nanotrac 250” Size Analyzer (Microtrac Inc.), and was 5.8 nm after 24 hours of storage at room temperature. The dispersion remained clear and no precipitation was observed for at least 5 days.

### Example 46

### Microblends of Bifenthrin with Phosphated Block Copolymer

Compositions of bifenthrin were prepared using triblock poly(ethylene oxide)-poly(propylene oxide)-poly(ethylene oxide) copolymer end-capped with phosphate groups (Dispersogen 3618, Clariant). Compositions were prepared using Dispersogen 3618 alone and in combination with Pluronic P123 (PEO₂₀-PPO₆₉-PEO₂₀) and/or Soprophor 3D33, anionic ethoxylated polyarylphenol surfactant. Briefly, the defined amounts of the components were mixed and melted together at 70° C. Compositions of the copolymer and copolymer/surfactant mixtures are presented in Table 16.

TABLE 16

| Components (in w/w %) | 7A | 7B | 7C | 7D | 7E |
|---|---|---|---|---|---|
| Bifenthrin (technical, 95 w/w %) | 1.05 | 1.05 | 1.05 | 1.05 | 1.05 |
| Dispersogen 3818 | 32.98 | 19.79 | 9.89 | 49.48 | 98.95 |
| Plutonic P123 | 32.98 | 39.58 | 44.53 | 49.47 | 0 |
| Soprophor 3D33 | 32.98 | 39.58 | 44.53 | 0 | 0 |

The melted compositions were allowed to cool to room temperature and 500 mg of each melt was added to 25 mL of deionized water and shaken. After 10 minutes of shaking, all samples had formed clear dispersions, containing 0.2 mg/ml of bifenthrin. The size of the particles in the microblend dispersions loaded with bifenthrin were determined by dynamic light scattering using “Nanotrac 250” Size Analyzer (Microtrac Inc.) at various time points (30 minutes, 4 hours, and 24 hours), and are presented in Table 17.

TABLE 17

| Time after dilution | | | | | |
|---|---|---|---|---|---|
| (hours) | 7A | 7B | 7C | 7D | 7E |
| 0.5 | 9.0 | 6.4 | 8.0 | 22.1 | 36.2 |
| 4 | 11.1 | 7.2 | 6.3 | 12.6 | 43.3 |
| 24 | 10.4 | 11.7 | N/D | 20.1 | 27.1 |

All dispersions remained clear after 24 hours of storage at room temperature with no visible precipitation.

### Example 47

### Microblends of Various Herbicides with the Mixtures of a Nonionic Block Copolymer and a Nonionic Ethoxylated Surfactant

Compositions of herbicides were prepared using melts of mixtures of nonionic block copolymer and ethoxylated surfactants. Specifically, tristyrylphenol ethoxylate (Soprophor BSU, Rhodia) was used in combination with Pluronic P123 (PEO₂₀-PPO₆₉-PEO₂₀). First, a stock blend of Pluronic P123 and Soprophor BSU was prepared by melting together 50 g of Pluronic P123 with 50 g of Soprophor BSU at 70° C. to form a clear, homogeneous melt. Composition of the copolymer/surfactant mixture was P123 Soprophor=1:1 by weight. 0.25 g of each of a number of herbicides technical with different logP values was added to 4.75 g of the stock Pluronic P123/Soprophor BSU mixture. The list of the herbicides and corresponding logP values (as referred in The Pesticide Manual, ed. C. D. S. Tomlin, 11^{th} edition) are presented in Table 18. The mixtures were heated at 70° C. for 10 min and shaken. All samples formed transparent homogeneous mixtures, which remained liquid on cooling to room temperature as also presented in Table 18.

TABLE 18

| Composition | Herbicide | Log P | Blend appearance |
|---|---|---|---|
| 9A | Carfentrazone-ethyl | 3.36 | clear, straw-colored liquid |
| 9B | Linuron | 3.00 | clear, straw-colored liquid |
| 9C | Dimethenamid-P | 2.05 | clear, straw-colored liquid |
| 9D | Prodiamine | 4.10 | clear orange liquid |
| 9E | Pendimethalin | 5.18 | clear brown liquid |
| 9F | Clomazone | 2.5 | clear, straw-colored liquid |

100 mg of the each blend was rehydrated in 5 ml of water upon shaking. All samples were dissolved in less than 10 minutes. The targeted content of insecticide in the microblend dispersion was 4.5 mg/ml. The microblend loading capacity with respect to insecticide was 9 w/w %. The size of the particles in the microblend dispersions loaded with herbicides (as determined by dynamic light scattering using “Nanotrac 250” Size

Analyzer (Microtrac Inc.)), and dispersions appearance after various time intervals of the storage at room temperature are presented in Table 19.

TABLE 19

| | Particle | | Particle | Particle | |
|---|---|---|---|---|---|
| | size (nm) | Dispersion | size (nm) | size (nm) | Dispersion |
| Compo- | in 2 | appearance | in 4 | in 24 | appearance |
| sition | hours | in 2 hours | hours | hours | in 24 hours |
| 9A | 14.8 | clear | 12.4 | 12.9 | clear |
| 9B | 15.6 | clear | 11.6 | 12.3 | clear |
| 9C | 15.0 | clear | 11.8 | 12.1 | clear |
| 9D | 15.0 | clear | 12.6 | 12.6 | clear |
| 9E | 15.6 | clear | 12.3 | 12.5 | trace of |
| | | | | | precipitation |
| 9F | 15.1 | clear | 11.5 | 12.1 | clear |

A11 dispersions, except the microblend containing pendimethalin (composition 9E in Table 18), remained stable after 24 hours of storage at room temperature. Traces of precipitation were observed in microblend dispersions loaded with pendimethalin at the 24 hour point.

### Example 48

### Microblends of Bifenthrin with Polyarylphenol Ethoxylate

Compositions of bifenthrin were prepared using a polyarylphenol ethoxylate (Adsee 775, AKZO Nobel). Compositions were prepared using Adsee 775 in combination with Pluronic P123 (PEO₂₀-PPO₆₉-PEO₂₀) and Soprophor 3D33, anionic ethoxylated polyarylphenol surfactant. Briefly, the defined amounts of the components were mixed and melted together at 70° C. Compositions of the copolymer and copolymer/surfactant mixtures are presented in Table 20.

TABLE 20

| Components (in w/w %) | 11A | 11B | 11C |
|---|---|---|---|
| Bifenthrin (technical, 95 w/w %) | 1.05 | 1.05 | 1.05 |
| Adsee 775 | 5.00 | 10.00 | 25.00 |
| Pluronic P123 | 46.98 | 44.48 | 36.98 |
| Soprophor 3D33 | 46.98 | 44.48 | 36.98 |

The melted compositions were allowed to cool to room temperature and 500 mg of each melt was added to 25 mL of deionized water and shaken. After 10 minutes of shaking, all samples had formed clear dispersions, containing 0.2 mg/ml of bifenthrin. The size of the particles in the microblend dispersions loaded with bifenthrin were determined by dynamic light scattering using “Nanotrac 250” Size Analyzer (Microtrac Inc.) at various time points (30 minutes, 4 hours, and 24 hours), and are presented in Table 17.

TABLE 21

| Time after dilution | Particle size (nm) | | |
|---|---|---|---|
| (hours) | 11A | 11B | 11C |
| 0.5 | 201 | 497 | 173 |
| 4 | 228 | 412 | 209 |
| 24 | 214 | 367 | 268 |

### Example 49

### Microblends of Various Herbicides with the Mixtures of a Nonionic Block Copolymer and a Nonionic Ethoxylated Surfactant

Compositions of herbicides were prepared using melts of mixtures of nonionic block copolymer and ethoxylated surfactants. Specifically, tristyrylphenol etoxylate (Soprophor BSU, Rhodia) was used in combination with Pluronic P123 (PEO₂₀-PPO₆₉-PEO₂₀). The list of the herbicides and corresponding log P values (the log P values were measured according procedure described by Donovan and Pescatore, J Chromatography A 2002, 952, 47-61) are presented in Table 22. All log P values were measured at pH 7, except for clethodim, measured at pH 2. First, a stock blend of Pluronic P123 and Soprophor BSU was prepared by melting together 50 g of Pluronic P123 with 50 g of Soprophor BSU at 70° C. to form a clear, homogeneous melt. Composition of the

copolymer/surfactant mixture was P123:Soprophor=1:1 by weight. 0.05 g of each of a number of herbicides technical with different log P values was added to 0.95 g of the stock Pluronic P123/Soprophor BSU mixture. The mixtures were heated at 70° C. for 10 min and shaken. All samples formed transparent homogeneous mixtures, which remained liquid on cooling to room temperature (Table 22).

TABLE 22

| Composition | Herbicide | Log P | Blend appearance |
|---|---|---|---|
| 10A | Butachlor | 4.15 | Clear liquid |
| 10B | Diflufenican | 4.76 | Turbid liquid |
| 10C | Dinocap | 5.43 | Clear, yellow liquid |
| 10D | Trifluralin | 5.08 | Orange, clear liquid |
| 10E | Fluazifop-butyl | 4.42 | clear brown liquid |
| 10F | Dithiopyr | 4.28 | clear, straw-colored liquid |
| 10G | Clethodim | 4.24* | Clear liquid |
| 10H | Ioxynil octanoate | 5.60 | Clear liquid |

*measured at pH 2.

100 mg of the each blend was rehydrated in 5 ml of water upon shaking. All samples were dissolved in less than 10 minutes. The targeted content of insecticide in the microblend dispersion was 5.0 mg/ml. The microblend loading capacity with respect to insecticide was 5 w/w %. The size of the particles in the microblend dispersions loaded with herbicides (as determined by dynamic light scattering using “Nanotrac 250” Size Analyzer (Microtrac Inc.)), and dispersions appearance after various time intervals of the storage at room temperature are presented in Table 23.

TABLE 23

| | Particle | | Particle | Particle | |
|---|---|---|---|---|---|
| | size (nm) | Dispersion | size (nm) | size (nm) | Dispersion |
| Compo- | in 2 | appearance | in 4 | in 24 | appearance |
| sition | hours | in 2 hours | hours | hours | in 24 hour |
| 10A | 14.1 | clear | 13.46 | 14.54 | clear |
| 10B | ND | precipitate | ND | ND | precipitate |
| 10C | 12.97 | clear | 10.71 | 15.33 | clear |
| 10D | 14.68 | clear | 9.96 | 14.06 | clear |
| 10E | 14.32 | clear | 12.82 | 14.02 | clear |
| 10F | 14.2 | clear | 13.01 | 14.28 | clear |
| 10G | 14.08 | clear | 13.11 | 14.57 | clear |
| 10H | 14.90 | clear | 12.64 | 15.26 | clear |

All dispersions, except the microblend containing diflufenican (composition 00B in Table 23), remained stable after 24 hours of storage at room temperature. Trace of precipitation was observed in the microblend dispersion loaded with diflufenican at the 2 hour point.

### Example 50

### Soil Mobility of Bifenthrin Microblends

The evaluation of the soil mobility of the bifenthrin microblends according to the invention was performed using soil thin layer chromatography (s-TLC). Air-dried greenhouse topsoil, sieved to pass through with a 250 μm sieve was used to prepare s-TLC plates. Thirty mL of distilled water was added to 60 g of the sieved soil and the mixture was thoroughly grounded until a smooth, moderately fluid slurry was obtained. The soil slurry was quickly spread evenly across a clean grooved glass plate. Plates contained 9×1 cm channels cut to a depth of 2 mm, with the channels spaced 1 cm apart. Plates were allowed to dry at room temperature over 24 hours. A horizontal line was scribed 12.5 cm above the plate base through the soil layer before the soil dried completely. Bifenthrin microblends used in these experiments were prepared using a bifenthrin sample spiked with ¹⁴C-radiolabeled bifenthrin to achieve reasonable sensitivity. Aqueous dispersions of microblends with concentrations of 10% were used in these experiments. Aliquots of each radiolabeled microblend were spotted 1.5 cm above the plate base. ¹⁴C-labeled sulfentrazone and suspension of ¹⁴C-labeled bifenthrin were used as controls.

The treated plate was placed in a Gelman™ chromatographic s-TLC chamber with the spotted zone placed near to the eluant (distilled water) reservoir. The chamber was elevated 1 cm at the end opposite the water reservoir to provide a slight incline. A 1 cm width section of paper was used per lane to wick water from the reservoir to the soil plate. The water front was allowed to migrate to the 12.5 cm scribed line, at which time the wicks were removed from the reservoir. The plates were then dried overnight at room temperature.

The s-TLC were then scanned for 2 hours using a Packard InstantImager™ TLC plate scanner. R_{f} values were determined from the images obtained using the following equation (1):

$${R}_{f} = \frac{Distance moved by microblend}{Distance moved by the solvent} \qquad ( 1 )$$

and are presented in Table 23.

TABLE 23

| | Ratio of the components | |
|---|---|---|
| Components of microblend | (by weight) | R_{f} |
| Pluronic F127, Pluronic P85 | 1:1 | 0.21 |
| Pluronic F127, Pluronic L121 | 5:1 | 0.12 |
| Pluronic F127, Pluronic P123, | 5:4:1 | 0.35 |
| Pluronic L121 | | |
| Tetronic T908 | N/A | 0.08 |
| Tetronic T1107 | N/A | 0.10 |
| Tetronic T90R4, Pluronic F127 | N/A | 0.14 |
| Tetronic T908, Soprophor BSU | 1:1 | 0.33 |
| Pluronic F127, Pluronic P123, | 2:2:1 | 0.23 |
| Agnique 90 C-4 | | |
| Tetronic T908, Ethoquad C/25 | 19:1 | 0.10 |
| Pluronic P85 | N/A | 0.07 |
| Pluronic F127 | N/A | 0.15 |
| Pluronic P123 | N/A | 0.25 |
| Pluronic L121 | N/A | 0.00 |
| Pluronic P123, Pluronic P85 | 1:1 | 0.33 |
| Pluronic P123, Pluronic L121 | 1:1 | 0.17 |
| Pluronic F127, Pluronic P123, | 3:3:1 | 0.46 |
| Zonyl FS300 | | |
| Pluronic P123 + Soprophor 4D 384 | 1:1 | 0.64 |
| Pluronic P123 + Soprophor BSU | 1:1 | 0.58 |
| Pluronic P123 + Soprophor 3D 33 | 1:1 | 0.52 |
| Pluronic F127 + Soprophor 4D 384 | 1:1 | 0.51 |
| Pluronic F127 + Soprophor BSU | 1:1 | 0.42 |
| Pluronic F127 + Soprophor 3D 33 | 1:1 | 0.40 |
| Sulfentrazone | N/A | 1.0 |
| Bifenthrin | N/A | 0.00 |

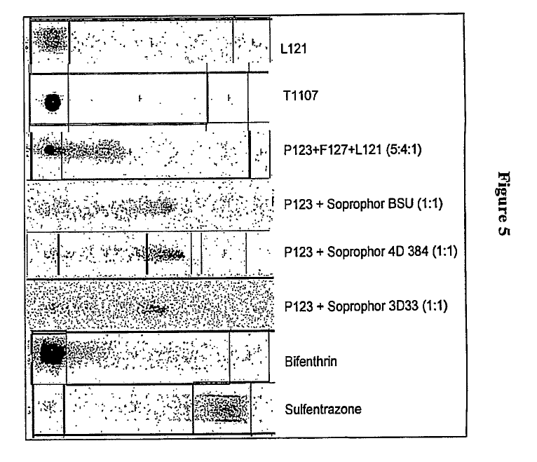

FIG. 5 demonstrates the movement of several radiolabeled bifenthrin microblends on a s-TLC plate. The concentrations of bifenthrin are indicated by the depth of the shading in the radio trace. These data indicate that bifenthrin incorporated into microblend shows improved soil movement compared to the pure bifenthrin.

### Example 51

### Soil Mobility of Bifenthrin Microblends

The soil mobility of the bifenthrin microblends with various compositions of polymer/surfactant components was tested using soil TLC technique. Specifically, s-TLC plates were developed twice with water solvent. The soil mobility experiments were performed as described in Example 50 using ¹⁴C-labeled bifenthrin. The s-TLC plates were developed using water as a solvent twice followed by scanning for 2 hours using a Packard InstantImager™ TLC plate scanner after each of the development. R_{f} values were determined from the images and are summarized in Table 24.

TABLE 24

| | | R_{f} | |
|---|---|---|---|
| | Ratio of the | 1^{st} | 2^{nd} |
| | components | develop- | develop- |
| Components of the microblend | (by weight) | ment | ment |
| Pluronic F127, Pluronic P123, | 3:3:1 | 0.46 | 0.51 |
| Zonyl FS300 | | | |
| Pluronic P123 + Soprophor 4D 384 | 1:1 | 0.64 | 0.71 |
| Pluronic P123 + Soprophor BSU | 1:1 | 0.58 | 0.61 |
| Pluronic P123 + Soprophor 3D 33 | 1:1 | 0.52 | 0.56 |
| Pluronic F127 + Soprophor 4D 384 | 1:1 | 0.51 | 0.54 |
| Pluronic F127 + Soprophor BSU | 1:1 | 0.42 | 0.43 |
| Pluronic F127 + Soprophor 3D 33 | 1:1 | 0.40 | 0.42 |

Additional soil movement of bifenthrin was observed when the plate was developed the second time.

### Example 52

### Soil Mobility of Bifenthrin Microblends with Various Ratios of the Components

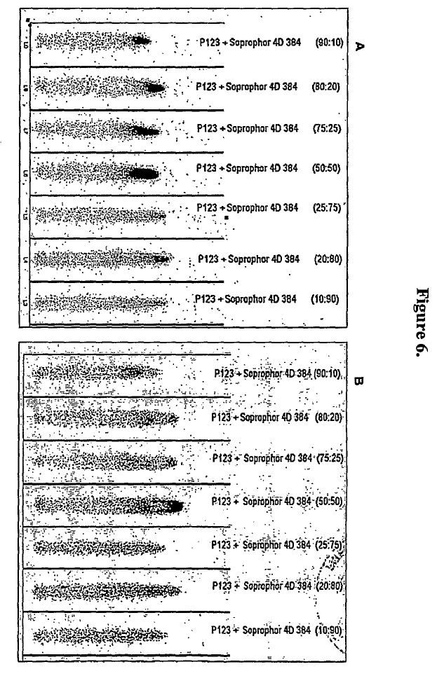

The soil mobility of the microblends with various weight ratios of polymer/surfactant components was tested using soil TLC technique. Specifically, the weight ratio of the components in the microblend containing Pluronic P123 and Soprophor 4D 384 was varied from 10:90 to 90:10. The soil mobility experiments were performed as described in Example 50 using ¹⁴C-labeled bifenthrin. The s-TLC plate was developed using water as a solvent followed by scanning for 2 hours using a Packard InstantImager™ TLC plate scanner. After that s-TLC plates were developed again using the same procedure, dried, and scanned one more time. The images obtained after both developments are presented in FIG. 6. R_{f} values were determined from the images and are summarized in Table 25.

Soil mobilities with comparable R_{f} values but significantly different distribution of the bifenthrin along the TLC traces were observed for the microblends with different compositions. An increase in the content of the second component, Soprophor 4D 384 anionic ethoxylated surfactant, from 10% to 50% led to the pronounced concentration of bifenthrin at the front of the s-TLC trace. The further increase in the content of Soprophor 4D 384 in the microblend from 50% to 90% resulted in more uniform distribution of the bifenthrin along the s-TLC trace. Additional soil movement of bifenthrin was observed when the plate was developed the second time. The presented data are evident that varying the ratio of the microblend components impacts the soil mobility.

TABLE 25

R_{f}

| Pluronic P123:Soprophor 4D 384 | 1^{st} | 2^{nd} |
|---|---|---|
| ratio (by weight) | development | development |
| 90:10 | 0.59 | 0.59 |
| 80:20 | 0.65 | 0.67 |
| 75:25 | 0.63 | 0.68 |
| 50:50 | 0.64 | 0.71 |
| 25:75 | 0.68 | 0.62 |
| 20:80 | 0.69 | 0.70 |
| 10:90 | 0.68 | 0.60 |

The presented data are evident that varying the ratio of the microblend components impacts the soil mobility.

### Example 53

### Biological Testing of a Microblend

The microblend prepared in Example A3 above was dispersed in water and centrifuged to remove any visible aggregates. The resulting supernatant contained 77.3% of the targeted Bifenthrin concentration. This material was compared to a commercially available sample of Talstar One Bifenthrin (commercially available from FMC Corporation) which upon analysis measured 81.2% of the targeted Bifenthrin concentration. The two samples were evaluated in the following series of assays:

A. Diet Disk Assay: This assay measures the response of 5th instar tobacco bud worm (TBW) to a single presentation of the formulations. The gut dwell time is estimated to be about 2 hours. The microblend had an LD50 value of 80.4 ppm. Talstar One had an LD50 of 233.9 ppm.

Nanoparticle formulations were sub sampled by melting formulations at 65° C. (except Lactose WP) and removing the melted sample to a tared tube. Based on the sample weight, samples were reconstituted using distilled water to obtain a 1:100 dilution. All subsequent dilutions used a corresponding blank (without bifenthrin) nanoparticle formation to maintain a constant block copolymer concentration of 1:100. All dilutions for Talstar One samples were made in distilled water and technical bifenthrin was diluted in acetone. The highest concentration was 750 ppm and decreased using 1:3 dilutions to 9 ppm. The concentration of all diluted samples was determined by HPLC chromatography and the true concentrations were used in the probit analysis for calculating LD₅₀ and LD₉₀ values. Diluted samples were applied to the diet disks within one hour of their preparation.

5^{th} instar TBW weighing 160 mg+/−16 mg were selected and placed into empty 32 well CDC International rearing trays. Trays were then sealed with a plastic lid and the TBW were allowed to fast 90 minutes prior to the assay. Eight larvae were used for each data point.

The diet disks for this treatment were prepared by pouring molten Stoneville diet, heated to 65° C., into 50 ml Corning plastic centrifuge tubes and centrifuging 10 minutes at 4,000×g at room temperature to remove particulate matter. A number “0” cork borer was inserted into the clarified diet to obtain diet cores. These diet cores were then sliced into 4×1 mm disks using a single-edged razor blade and placed upon a piece of moistened filter paper just prior to sample application.

While TBW larvae were fasting, 1 ul of the diluted formulation samples were applied to the surface of the diet disk. After the 90 minute fast, treated diet disks were presented to the TBW, which were allowed 30 minutes to consume the diet. After 30 minutes the percentage of uneaten diet disk was recorded. Larvae were subsequently observed an additional 30 minutes to observe the onset of a vomiting reaction in response the bifenthrin treatment. After this observation period, larvae were distributed to 32 well CDC International rearing trays containing Stoneville diet and returned to the incubator (28° C.; 65% RH; 14:10 Light:Dark). Morbidity and mortality was recorded daily for three days. Morbidity was determined as the inability of a larva to right itself after 15 seconds after being turned upside down. LD₅₀ and LD₉₀ determinations were made using XL Stat software were morbid and dead cohorts were pooled together.

B. Topical Assay: The topical assay measures the response of 5th instar TBW to a single dose of the formulations applied directly to the dorsal side of the 3rd thoracic segment. Larva are exposed to the sample continuously during the assay. The microblend had an LD50 value of 42.3 ppm. Talstar One had an LD50 of 84.4 ppm.
C. Leaf Disk Assay: The leaf disk assay measures the response of 2^{nd} instar TBW to a single presentation of the formulations on a disc cut from true cotton leaves.

Serial dilutions of bifenthrin polymer complexes were prepared in DI water and a “blank” polymer mixture identical to those used in the preparation of the complex. One (1)-cm leaf discs were cut from cotton true-leaves and placed in 24-cell well plates containing agar; 24 discs/treatment (rate) were prepared. A 15-ul droplet of treatment solution was applied to the center of each cotton leaf disc and allowed to dry in a fume hood (ca. 1-2 hrs). One (1) T13W 2nd-instar larva was placed into each cell. The plates were covered with adhesive-backed, ventilated plastic film. And placed in an environmental chamber @ c. 27 C (80 F). At 24, 48, 72, and 96 HAT, the plates were inspected to determine larval mortality; at 96 HAT, feeding evaluations were recorded.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A microblend comprising:
(a) at least one amphiphilic polymer comprising at least one hydrophilic segment which is a polyethylene oxide block and at least one hydrophobic segment which is a polypropylene oxide block; and
(b) a pesticide which is substantially insoluble in water;
wherein said microblend is substantially free of added water and/or organic solvent.

22. The microblend of claim 21 wherein the weight ratio of component (a) to component (b) is between 1:1 and 20:1.

23. The microblend of claim 21 wherein said microblend comprises a mixture of polyethylene oxide-polypropylene oxide block copolymers.

24. The microblend of claim 23 wherein said microblend comprises two polyethylene oxide-polypropylene oxide-polyethylene oxide triblock copolymers; and wherein one of the copolymers has a polyethylene oxide content of greater than or equal to 70% and the other has a polyethylene oxide content of between about 10% and about 50%.

25. The microblend of claim 21 wherein said microblend further comprises a tristyryl phenol surfactant.

26. The microblend of claim 23 wherein said microblend further comprises a tristyryl phenol surfactant.

27. The microblend of claim 24 wherein said microblend further comprises a tristyryl phenol surfactant.

28. The microblend of claim 21 wherein component (b) is selected from the group consisting of bifenthrin, flutriafol, azoxystrobin, cypermethrin, profenofos, abamectin, fipronil, spinosad, pyridalyl, carfentrazone-ethyl, linuron, dimethenamid-P, prodiamine, pendimethaline, clomazone, butachlor, diflufenican, dinocap, trifluralin, fluazifop-butyl, dithiopyr, clethodim and ioxynil octanoate.

29. The microblend of claim 21 wherein component (b) is bifenthrin.

30. A pesticidal composition comprising a microblend comprising:
(a) at least one amphiphilic polymer comprising at least one hydrophilic segment which is a polyethylene oxide block and at least one hydrophobic segment which is a polypropylene oxide block; and
(b) a pesticide which is substantially insoluble in water;
wherein said microblend is substantially free of added water and/or organic solvent.

31. The pesticidal composition of claim 30 wherein said composition is a dust formulation or a water dispensible granule, tablet or wettable powder.

32. The pesticidal composition of claim 30 wherein the weight ratio of component (a) to component (b) is between 1:1 and 20:1.

33. The pesticidal composition of claim 30 wherein said microblend comprises a mixture of polyethylene oxide-polypropylene oxide block copolymers.

34. The pesticidal composition of claim 33 wherein said microblend comprises two polyethylene oxide-polypropylene oxide-polyethylene oxide triblock copolymers; and wherein one of the copolymers has a polyethylene oxide content of greater than or equal to 70% and the other has a polyethylene oxide content of between about 10% and about 50%.

35. The pesticidal composition of claim 30 wherein said microblend further comprises a tristyryl phenol surfactant.

36. The pesticidal composition of claim 30 wherein component (b) is selected from the group consisting of bifenthrin, flutriafol, azoxystrobin, cypermethrin, profenofos, abamectin, fipronil, spinosad, pyridalyl, carfentrazone-ethyl, linuron, dimethenamid-P, prodiamine, pendimethaline, clomazone, butachlor, diflufenican, dinocap, trifluralin, fluazifop-butyl, dithiopyr, clethodim and ioxynil octanoate.

37. A method of controlling pests comprising applying a composition comprising a microblend comprising: (a) at least one amphiphilic polymer comprising at least one hydrophilic segment which is a polyethylene oxide block and at least one hydrophobic segment which is a polypropylene oxide block; and (b) a pesticide which is substantially insoluble in water; wherein said microblend is substantially free of added water and/or organic solvent, to a location infested with pests or likely to be infested by pests.

38. The method of claim 37 wherein said microblend comprises a mixture of polyethylene oxide-polypropylene oxide block copolymers.

39. The method of claim 38 wherein said microblend comprises two polyethylene oxide-polypropylene oxide-polyethylene oxide triblock copolymers; and wherein one of the copolymers has a polyethylene oxide content of greater than or equal to 70% and the other has a polyethylene oxide content of between about 10% and about 50%.

40. The method of claim 37 wherein said microblend further comprises a tristyryl phenol surfactant.

41. The method of claim 37 wherein component (b) is selected from the group consisting of bifenthrin, flutriafol, azoxystrobin, cypermethrin, profenofos, abamectin, fipronil, spinosad, pyridalyl, carfentrazone-ethyl, linuron, dimethenamid-P, prodiamine, pendimethaline, clomazone, butachlor, diflufenican, dinocap, trifluralin, fluazifop-butyl, dithiopyr, clethodim and ioxynil octanoate.
